(19) United States
(12) Patent Application Publication
(10) Pub. No.: US 2019/0013591 A1
(43) Pub. Date: Jan. 10, 2019

(54) MICROSTRIP PATCH ANTENNA APERTURE COUPLED TO A FEED LINE, WITH CIRCULAR POLARIZATION

(71) Applicant: Drayson Technologies (Europe) Limited, Oxfordshire (GB)

(72) Inventors: Soheyl SOODMAND, London (GB); Bruno Roberto FRANCISCATTO, London (GB); Manuel Pinuela RANGEL, London (GB)

(21) Appl. No.: 15/748,729

(22) PCT Filed: Jul. 27, 2016
(86) PCT No.: PCT/EP2016/067893

§ 371 Date: Jan. 30, 2018

(30) Foreign Application Priority Data
Jul. 30, 2015 (GB) 1513565.0
Sep. 3, 2015 (GB) 1515664.9

(51) Int. Cl. H01Q 21/06; H01Q 1/48; H01Q 13/10; H01Q 9/04

(52) U.S. Cl. CPC H01Q 21/064; H01Q 9/0428; H01Q 13/10; H01Q 1/48

(57) ABSTRACT

An antenna is disclosed. The antenna comprises a feedline (101), a ground plane (102) and a radiator (103). The feedline has a path in a first plane, the path having a first arm (1011) and a second arm (1012) perpendicular to the first arm. The ground plane is provided in a second plane spaced apart from, and parallel to, the first plane. The ground plane has a ground plane slot (1021) therein with a path in the second plane. The path of the ground plane slot intersects the path of the feedline at a first position on the first arm and a second position on the second arm when the second plane is projected into the first plane. The radiator is separated from the feedline by the ground plane, and is provided in a third plane spaced apart from, and parallel to, the second plane.

### TECHNICAL FIELD

The present invention relates generally to the field of antennas.

### BACKGROUND

Antennas are used in many fields such as wireless energy harvesting, wireless energy transfer and telecommunications. Antennas enable the transmission and/or reception of energy or signals, depending upon the application. The following characteristics can be important for an antenna:
high gain;
good return loss;
circular polarisation (this can be particularly important in reception mode as this provides an orientation-independent reception capability and allows the reception of more wireless energy compared with a linear polarisation antenna);
a large antenna effective area (to increase the amount of RF energy transmitted or received);
a small footprint
preferably multiband transmission and/or reception capability (to allow RF energy to be transmitted and/or received in different frequency bands);
preferably low production cost;
preferably lightweight.

The present invention aims to provide an antenna with one or more of the above characteristics.

### SUMMARY

The present invention provides an antenna. The antenna comprises a feedline, a ground plane and a radiator. The feedline has a path in a first plane, the path having a first arm and a second arm perpendicular to the first arm. The ground plane is provided in a second plane spaced apart from, and parallel to, the first plane. The ground plane has a ground plane slot therein with a path in the second plane. The path of the ground plane slot intersects the path of the feedline at a first position on the first arm and a second position on the second arm when the second plane is projected into the first plane. The radiator is separated from the feedline by the ground plane, and is provided in a third plane spaced apart from, and parallel to, the second plane.

The present invention also provides a device comprising an antenna as described above, wherein the radiator is printed or plated onto the case of the device.

### BRIEF DESCRIPTION OF THE DRAWINGS

Embodiments of the invention will now be described with reference to the accompanying drawings, in which like reference numbers designate the same or corresponding parts and in which:

FIG. 1A shows an exploded view of an antenna according to a first embodiment of the present invention.

FIG. 1B shows a plan view of the antenna according to the first embodiment of the present invention.

FIG. 2 shows a modification of the antenna of the first embodiment.

FIG. 3A shows an antenna according to a second embodiment of the present invention.

FIG. 3B shows a modification of the antenna of the second embodiment.

FIG. 4A shows a view of a radiator of an antenna used in simulations.

FIG. 4B shows a view of a ground plane of the antenna used in simulations.

FIG. 4C shows a view of a feedline of the antenna used in simulations.

FIG. 5A comprises simulation results showing how the magnitude of the S-parameter S11 varies with frequency for changes in the width of the first ground plane slot in the antenna.

FIG. 5B comprises simulation results showing a Smith Chart of the variation in the S-parameter S11 with frequency for changes in the width of the first ground plane slot in the antenna.

FIG. 6A comprises simulation results showing how the magnitude of the S-parameter S11 varies with frequency for changes in the width of the second ground plane slot in the antenna.

FIG. 6B comprises simulation results showing a Smith Chart of the variation in the S-parameter S11 with frequency for changes in the width of the second ground plane slot in the antenna.

FIG. 7A comprises simulation results showing how the magnitude of the S-parameter S11 varies with frequency for changes in the radius of the first ground plane slot to the centre of the slot.

FIG. 7B comprises simulation results showing a Smith Chart of the variation in the S-parameter S11 with frequency for changes in the radius of the first ground plane slot to the centre of the slot.

FIG. 8A comprises simulation results showing how the magnitude of the S-parameter S11 varies with frequency for changes in the radius of the second ground plane slot to the centre of the slot.

FIG. 8B comprises simulation results showing a Smith Chart of the variation in the S-parameter S11 with frequency for changes in the radius of the second ground plane slot to the centre of the slot.

FIG. 9A comprises simulation results showing how the magnitude of the S-parameter S11 varies with frequency for changes in the arc angle of the first ground plane slot.

FIG. 9B comprises simulation results showing a Smith Chart of the variation in the S-parameter S11 with frequency for changes in the arc angle of the first ground plane slot.

FIG. 10A comprises simulation results showing how the magnitude of the S-parameter S11 varies with frequency for changes in the arc angle of the second ground plane slot.

FIG. 10B comprises simulation results showing a Smith Chart of the variation in the S-parameter S11 with frequency for changes in the arc angle of the second ground plane slot.

FIG. 11A comprises simulation results showing how the magnitude of the S-parameter S11 varies with frequency for changes in the radius from the centre of the inner section of the radiator to the outer edge of the inner section.

FIG. 11B comprises simulation results showing a Smith Chart of the variation in the S-parameter S11 with frequency for changes in the radius from the centre of the inner section of the radiator to the outer edge of the inner section.

FIG. 12A comprises simulation results showing how the magnitude of the S-parameter S11 varies with frequency for changes in the distance from the centre of the inner section of the radiator to the inside edge of the outer ring of the outer section of the radiator.

FIG. 12B comprises simulation results showing a Smith Chart of the variation in the S-parameter S11 with frequency for changes in the distance from the centre of the inner section of the radiator to the inside edge of the outer ring of the outer section of the radiator.

FIG. 13A comprises simulation results showing how the magnitude of the S-parameter S11 varies with frequency for changes in the distance from the centre of the inner section of the radiator to the outside edge of the outer ring of the outer section of the radiator.

FIG. 13B comprises simulation results showing a Smith Chart of the variation in the S-parameter S11 with frequency for changes in the distance from the centre of the inner section of the radiator to the outside edge of the outer ring of the outer section of the radiator.

FIG. 14A comprises simulation results showing how the magnitude of the S-parameter S11 varies with frequency for changes in the width of the separating ring between the inner and outer sections of the radiator.

FIG. 14B comprises simulation results showing a Smith Chart of the variation in the S-parameter S11 with frequency for changes in the width of the separating ring between the inner and outer sections of the radiator.

FIG. 15A comprises simulation results showing how the magnitude of the S-parameter S11 varies with frequency for changes in the length of each of the first and second inner radiator slots.

FIG. 15B comprises simulation results showing a Smith Chart of the variation in the S-parameter S11 with frequency for changes in the length of each of the first and second inner radiator slots.

FIG. 16A comprises simulation results showing how the magnitude of the S-parameter S11 varies with frequency for changes in the width of the first and second inner radiator slots and/or the width of the first and second outer radiator slots.

FIG. 16B comprises simulation results showing a Smith Chart of the variation in the S-parameter S11 with frequency for changes in the width of the first and second inner radiator slots and/or the width of the first and second outer radiator slots.

FIG. 17A comprises simulation results showing how the magnitude of the S-parameter S11 varies with frequency for changes in the length of each of the first and second outer radiator slots.

FIG. 17B comprises simulation results showing a Smith Chart of the variation in the S-parameter S11 with frequency for changes in the length of each of the first and second outer radiator slots.

FIG. 18A comprises simulation results showing how the magnitude of the S-parameter S11 varies with frequency for changes in the length of the outgoing feed of the feedline.

FIG. 18B comprises simulation results showing a Smith Chart of the variation in the S-parameter S11 with frequency for changes in the length of the outgoing feed of the feedline.

FIG. 19A comprises simulation results showing how the magnitude of the S-parameter S11 varies with frequency for changes in the angle between the diameter on which the first and second inner radiator slots lie and the path of the outgoing feed when the plane of the inner radiator slots is projected into the plane of the feedline.

FIG. 19B comprises simulation results showing a Smith Chart of the variation in the S-parameter S11 with frequency changes for changes in the angle between the diameter on which the first and second inner radiator slots lie and the path of the outgoing feed when the plane of the inner radiator slots is projected into the plane of the feedline.

FIG. 20 shows a modification of previous embodiments.

FIGS. 21A, 21B and 21C show a case for housing a feedline and ground plane, the case having a radiator printed or plated thereon.

### DETAILED DESCRIPTION OF EMBODIMENTS

### First Embodiment

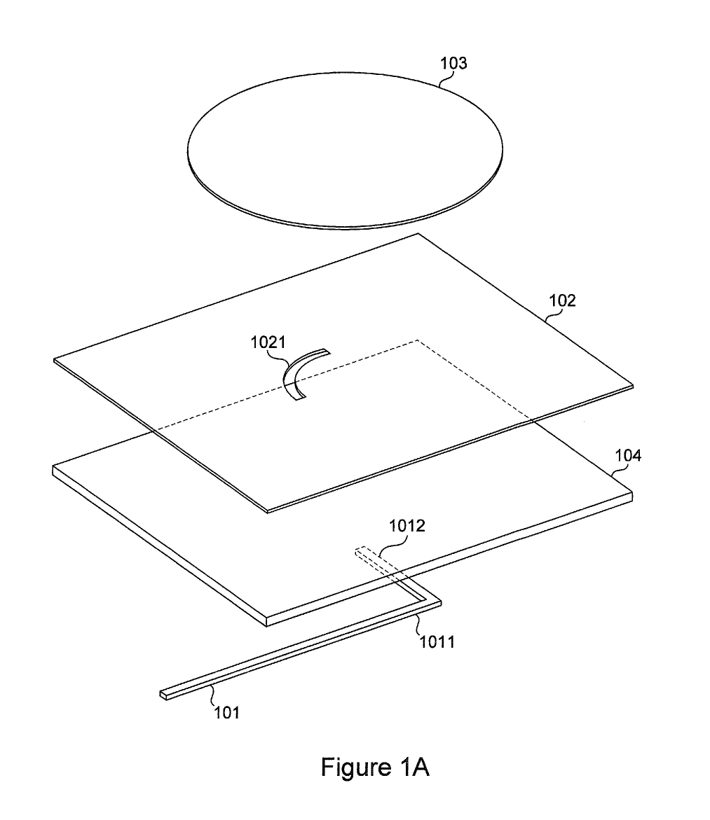

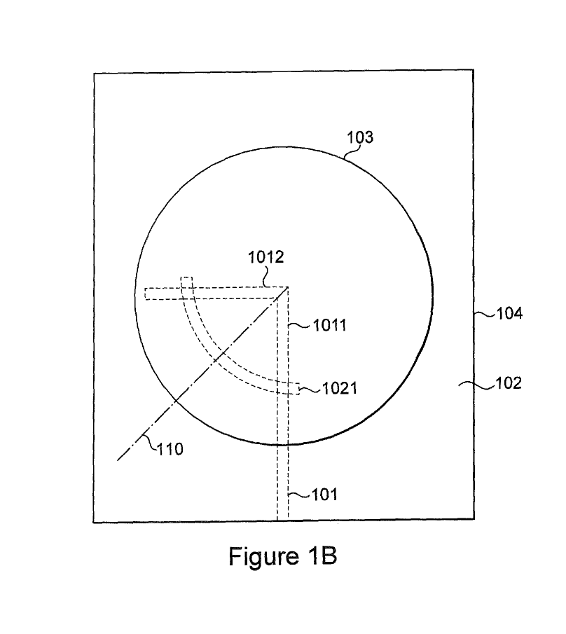

A first embodiment of the present invention will be described with reference to FIGS. 1A and 1B, which schematically show the components of an antenna.

The antenna comprises a feedline 101, a ground plane 102 with a ground plane slot 1021 therein and a radiator 103. The feedline 101, ground plane 102 and radiator 103 are all formed from an electrically conductive material, such as copper. It will be understood that, when the antenna is used in an energy collecting mode, for example, during energy harvesting, the radiator 103 acts as a radiation collector.

In this embodiment, the feedline 101 and ground plane 102 are conveniently formed as layers on each side of a substrate 104. The substrate is made from a dielectric material and provides a suitable mechanical support to hold the feedline 101 in a first plane and the ground plane 102 in a second plane spaced apart from, and parallel to, the first plane. Here, it will be understood by the skilled person that parallel to does not mean that the angle between the plane of the feedline 101 and the plane of the ground plane 102 is strictly zero degrees but that variations in the angle up to ±2.5 degrees are encompassed, as such variations will not significantly degrade performance of the antenna. It will be further understood that the substrate is not an essential component and that any suitable mechanical structure can be provided to hold the feedline 101 and the ground plane 102 in their respective planes.

In this embodiment, feedline 101 is a 50 ohm line and is conveniently formed from a microstrip, but could also be formed using a stripline. The feedline 101 has a first arm 1011 acting as an input feed and a second arm 1012, perpendicular to the first arm, that acts as an output feed. Referring to FIG. 1B, the path of the ground plane slot 1021 intersects the path of the feedline 101 at a first position on the first arm 1011 and a second position on the second arm 1012 when the plane of the ground plane is projected into the plane of the feedline (or vice versa).

Here, as throughout the description and claims, a projection is the transformation of points and lines in one plane onto another plane by connecting corresponding points on the two planes with parallel lines perpendicular to the planes. This is equivalent to shining a point light source located at infinity through one of the planes to form an image of whatever is provided on the plane on the other plane.

Each intersection of the projected ground plane slot 1021 with the feedline 101 acts as a source of transverse electromagnetic radiation (TEM). Circular polarisation is achieved when one of the TEM sources is rotated by a right angle (90 degrees) to the other. Accordingly, the first and second arms 1011, 1012 of the feedline are perpendicular to each other. However, it will be understood by the skilled person that perpendicular does not mean that the angle between the first and second arms 1011, 1012 is strictly 90 degrees but that variations in the angle up to ±2.5 degrees are encompassed, as such variations will not significantly degrade performance of the antenna. In addition, to provide the circular polarisation, the ground plane slot 1021 is configured such that the distance between the two intersections of the projected ground plane slot 1021 with the feedline 101 (that is, the distance between the TEM sources) provides a 90 degrees phase shift for the waveband of radiation to be transmitted and/or received. Furthermore, in this embodiment, the ground plane slot 1021 is a circular arc, and the feedline 101 and the ground plane 102 are positioned relative to each other such that the centre of the circular arc of the ground plane slot 1021 is at the intersection of the first arm 1011 and the second arm 1012 when the plane of the ground plane 102 is projected into the plane of the feedline 101 (or vice versa). Also, referring to FIG. 1B, the ground plane slot 1021 in this embodiment is orientated such that the bisector 110 of the arc angle (the centre angle) of the ground plane slot 1021 also bisects the angle between the first and second arms 1011, 1012 when the plane of the ground plane 102 is projected into the plane of the feedline 101 (or vice versa).

The first embodiment is therefore a single feed antenna. The required two orthogonal resonant modes are possible through series feed.

Turning now to the radiator 103, this is separated from the feedline 101 by the ground plane 102. The radiator 103 is held in a third plane spaced apart from, and parallel to, the ground plane 102. Here, it will again be understood by the skilled person that parallel to does not mean that the angle between the plane of the radiator 103 and the plane of the ground plane 102 is strictly zero degrees but that variations in the angle up to ±2.5 degrees are encompassed, as such variations will not significantly degrade performance of the antenna. The space between the radiator 103 and the ground plane 102 is preferably an air gap, as the inventors have found this improves the return loss of the antenna.

In this embodiment, the radiator 103 is circular and is positioned relative to the feedline 101 such that the centre of the radiator 103 is at the intersection of the first arm 1011 and the second arm 1012 when the plane of the radiator 103 is projected into the plane of the feedline 101 (or vice versa).

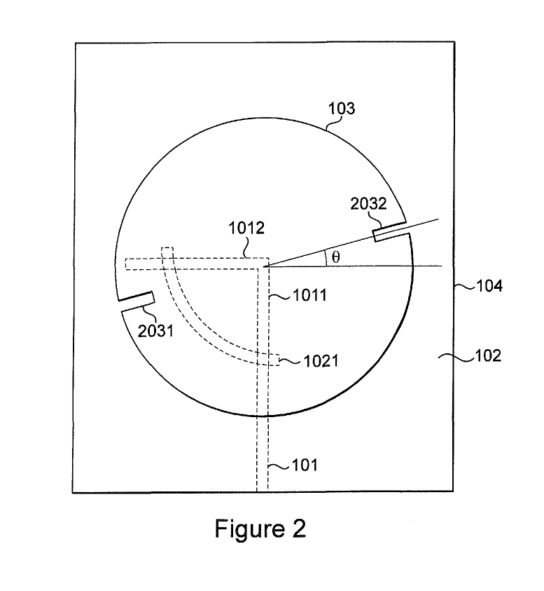

FIG. 2 shows a modification of the first embodiment, in which radiator 103 includes optional first 2031 and second 2032 radiator slots, the first 2031 and second 2032 radiator slots being on a diameter of the radiator 103 on opposite sides of the centre and at the edge of the radiator 103.

The diameter on which the first and second radiator slots 2031, 2032 lie forms an angle θ relative to the path of the outgoing feed 1012 when the plane of the ground plane 102 is projected into the plane of the feedline 101 (or vice versa).

This modification has been found by the inventors to have the effect of further amplifying the circular polarization characteristics of the antenna.

### Second Embodiment

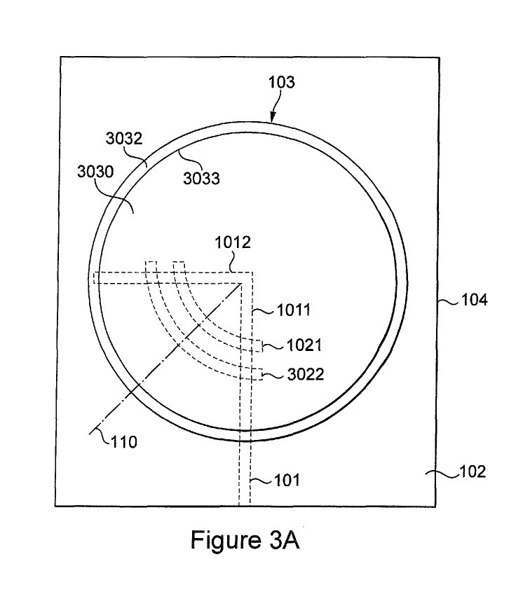

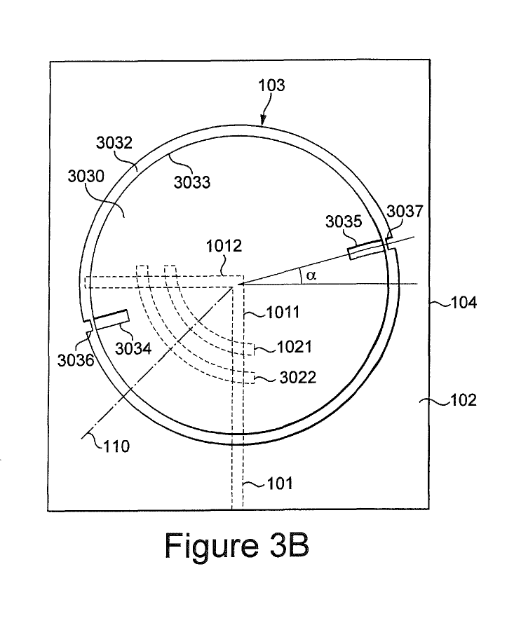

FIG. 3A shows a second embodiment of the present invention with dual band transmission and/or reception capability.

The second embodiment comprises a feedline 101, ground plane 102 and radiator 103, as in the first embodiment. However, to provide dual band transmission and/or reception capability, a second ground plane slot 3022 is provided in addition to the first ground plane slot 1021. Furthermore, the radiator 103 comprises a circular inner section 3030 and an outer section 3032 formed of an outer ring, the inner section 3030 and outer section 3032 being electrically separated by a separating ring 3033. In this embodiment, radiator 103 is formed as one continuous circle of copper (or other conductive material) and then the inner and outer sections 3030, 3032 are formed by removing a ring of copper (or other conductive material) to form the separating ring 3033. However, the inner and outer sections 3030, 3032 could be formed separately, and they could have a separating ring of insulating material therebetween.

The second embodiment provides dual band signal or energy transmission and/or reception capability. By way of non-limiting example, such an antenna could be used to transmit and/or receive signals (or energy) in the waveband of Wi-Fi (operating around 2.4 GHz) and, at the same time, the waveband of GSM (operating around 1.8 GHz—referred to as GSM 1800).

The path of the first ground plane slot 1021 intersects the path of the feedline 101 at a first position on the first arm 1011 and a second position on the second arm 1012 when the plane of the ground plane 102 is projected into the plane of the feedline 101 (or vice versa). The path of the second ground plane slot 3022 intersects the path of the feedline 101 at a third position on the first arm 1011 and a fourth position on the second arm 1012 when the plane of the ground plane 102 is projected into the plane of the feedline 101 (vice versa).

The second ground plane slot 3022 is configured such that the distance between the two intersections of the projected ground plane slot 3022 with the feedline provides a 90 degrees phase shift for the waveband of radiation in the second waveband to be transmitted and/or received. Furthermore, in this embodiment, the first and second ground plane slots 1021, 3022 are both circular arcs with the same centre. The feedline 101 and the ground plane 102 are positioned relative to each other such that the centre of the circular arcs of the ground plane slots 1021, 3022 is at the intersection of the first arm 1011 and the second arm 1012 when the plane of the ground plane 102 is projected into the plane of the feedline 101 (or vice versa). Also, both of the ground plane slots 1021, 3022 in this embodiment are orientated such that the bisector 110 of the arc angle (the centre angle) of the first ground plane slot 1021 is also a bisector of the arc angle of the second ground plane slot 3022, and furthermore bisects the angle between the first and second arms 1011, 1021 when the plane of the ground plane 102 is projected into the plane of the feedline 101 (or vice versa).

FIG. 3B shows a modification of the second embodiment, in which the inner section 3030 of radiator 103 optionally includes a first inner radiator slot 3034 and a second inner radiator slot 3035, the first 3034 and second 3035 inner radiator slots lying on a diameter of the inner section 3030 of the radiator 103 on opposite sides of the centre and at the edge of the inner section 3030.

Moreover, as shown in FIG. 3B, the outer section 3032 of the radiator 103 may optionally include a first outer radiator slot 3036 and a second outer radiator slot 3037, the first 3036 and second 3037 outer radiator slots lying on a diameter of the radiator 103 on opposite sides of the centre and at the outer edge of the outer section 3032.

The diameter on which the inner radiator slots 3034, 3035 lie is preferably the same diameter as that on which the outer radiator slots 3036, 3037 lie. The diameter on which the inner radiator slots 3034, 3035, and the outer radiator slots 3036, 3037 lie forms an angle α relative to the path of the outgoing feed 1012 when the plane of the ground plane 102 is projected into the plane of the feedline 101 (or vice versa).

This modification has been found by the inventors to have the effect of further amplifying the circular polarization characteristics of the antenna.

The present inventors performed experiments to determine parameters of the antenna shown in FIG. 3B that affect its performance.

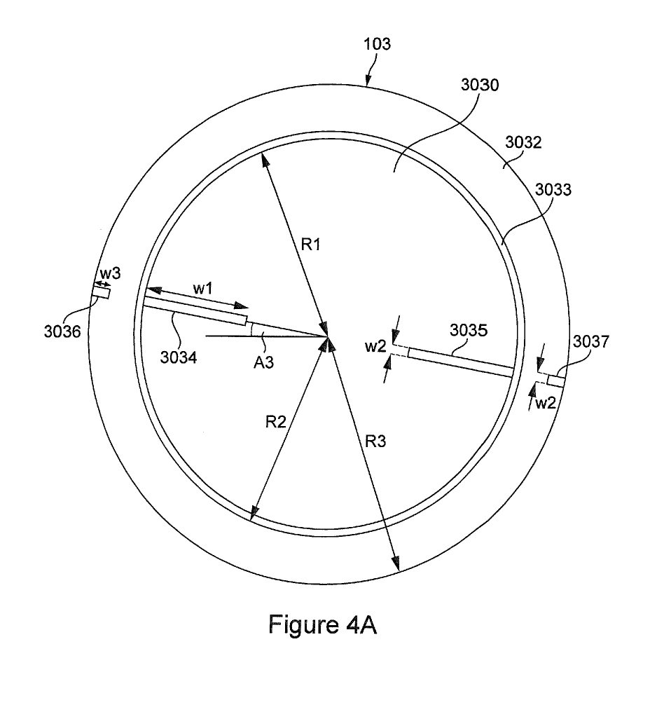

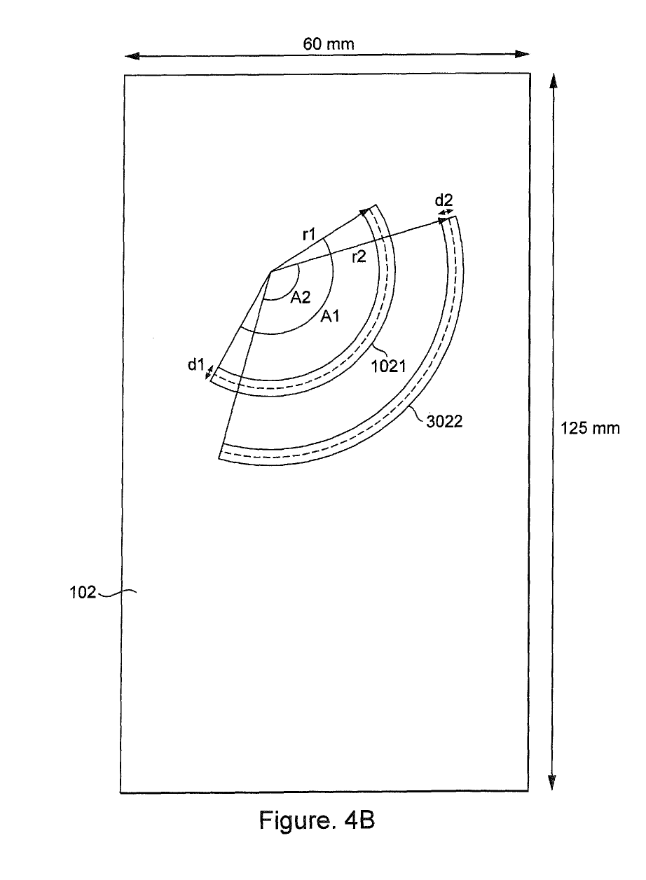

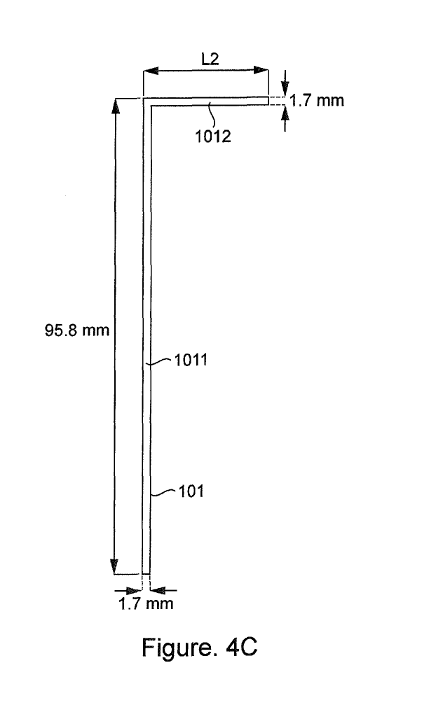

Referring to FIGS. 4A to 4C, the experiments performed by the inventors revealed that the following parameters affect the antenna performance:

d1: the width of the first ground plane slot 1021;
d2: the width of the second ground plane slot 3022;
r1: the radius of the first ground plane slot 1021 to the centre of the slot;
r2: the radius of the second ground plane slot 3022 to the centre of the slot;
A1: the arc angle (centre angle) of the first ground plane slot 1021;
A2: the arc angle (centre angle) of the second ground plane slot 3022;
R1: the radius from the centre of the inner section 3030 of the radiator 103 to the outer edge of the inner section 3030;
R2: the distance from the centre of the inner section 3030 of the radiator 103 to the inside edge of the outer ring of the outer section 3032 of the radiator 103;
R3: the distance from the centre of the inner section 3030 of the radiator 103 to the outside edge of the outer ring of the outer section 3032;
R2−R1: the width of the separating ring 3033;
w1: the length of each of the first 3034 and second 3035 inner radiator slots;
w2: the width of the first 3034 and second 3035 inner radiator slots and/or the first 3036 and second 3037 outer radiator slots;
w3: the length of each of the first 3036 and second 3037 outer radiator slots;
L2: the length of the outgoing feed 1012 of the feedline 101; and
A3: the angle between the diameter on which the first and second inner radiator slots 3034, 3035 and the first and second outer radiator slots 3036, 3037 lie and the path of the outgoing feed when the plane of the ground plane 102 is projected into the plane of the feedline 101 (or vice versa).

The present inventors performed simulations to determine a range of values for each respective parameter above that would provide acceptable performance of the antenna. For the purposes of the simulations, the substrate material was modelled with a thickness 0.76 mm and with the electrical characteristics of a low-loss laminate material, such as IS680-345 available commercially from ISOLA Group s.a.r.l.

In the field of antenna design, antennas are performance-rated using S-parameters which describe the input-output relationship of energy or power between ports or terminals of the antenna. One of the most commonly used performance ratings for antennas is the S11 parameter. The S11 parameter is known as the input port voltage reflection coefficient and represents how much power is reflected from the antenna for a given incident power. If Vinc is the voltage amplitude of the incident signal and Vref is the voltage amplitude of the reflected signal then S11=Vref/Vinc. The power reflection coefficient can then be expressed on a decibel (dB) scale as

S11 (dB)=−20·log(S11)

For example if S11=0 dB, then all the power is reflected from the antenna and nothing is radiated, or if S11=−10 dB and 3 dB of power is delivered to the antenna then the reflected power is −7 dB.

Acceptable antenna performance, as recognised by antenna engineers, is achieved for a reflection coefficient (S11) with a magnitude of at least 10 dB.

Accordingly, in the simulations, acceptable antenna performance was taken as having an S11 magnitude of at least 10 dB in at least one of the frequency ranges GSM1800 (1.85 to 1.88 GHz) and Wi-Fi (2.4 to 2.495 GHz). The simulations were performed using an antenna comprising three layers, in which the first layer relates to the radiator 103, as shown FIG. 4A, the second layer relates to the ground plane 102 as shown in FIG. 4B, and the third layer relates to the antenna feedline 101 as shown in FIG. 4C. In FIGS. 4A, 4B and 4C, the views are plan views looking through the layers as they would be assembled in a device.

Referring to FIG. 4B, the ground plane 102 was modelled with width 60 mm and length 125 mm. Referring to FIG. 4C, the feedline 101 was modelled with a width of 1.7 mm. The length L1 of the incoming feed of the feedline 101 was modelled as 95.8 mm.

The copper thickness was modelled as 35 microns.

The gap between the ground plane 102 and the radiator 103 was modelled as 5 mm.

The simulations of the antenna were performed using CST Microwave®.

The simulation results for each of these parameters will now be described. For each parameter, the simulation results comprise a S11 (dB) graph and a corresponding Smith Chart, which includes a superimposed Voltage Standing Wave Ratio (VSWR) circle with value 2:1 representing an S11 magnitude of 9.54 dB normalised for Z0=50 ohms.

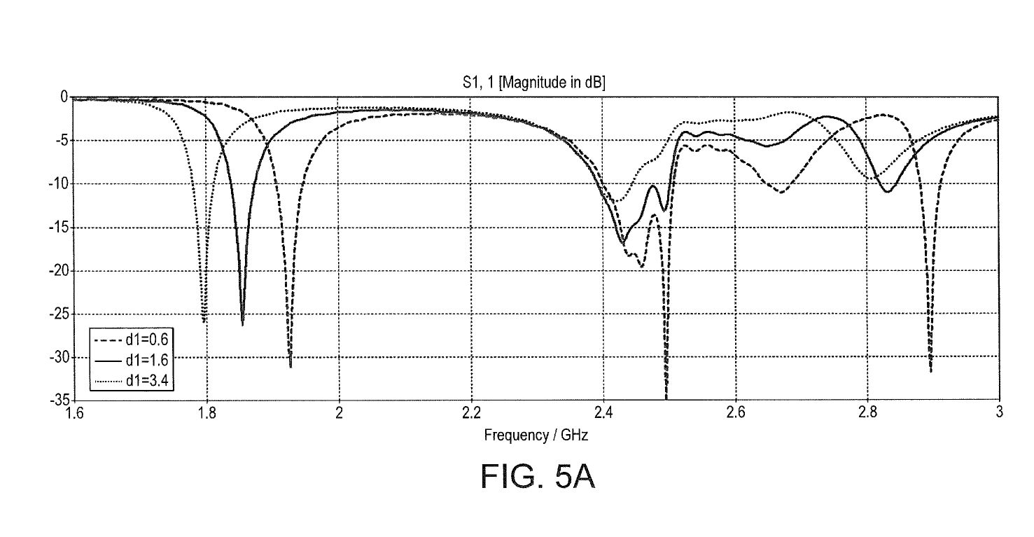

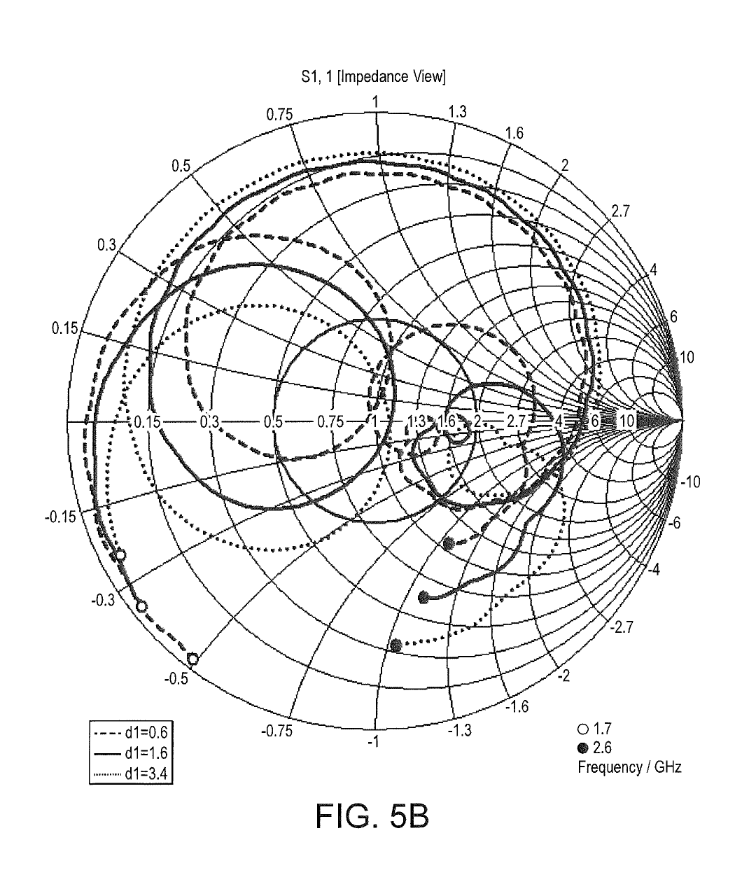

FIGS. 5A and 5B show the simulation results for the parameter d1, namely the width of the first ground plane slot 1021. The simulation results show variations in S11 over the relevant frequency range for various values of the parameter d1. Referring to FIG. 5A, the simulation results demonstrate that acceptable performance is achieved when d1 is between 0.6 mm and 3.4 mm.

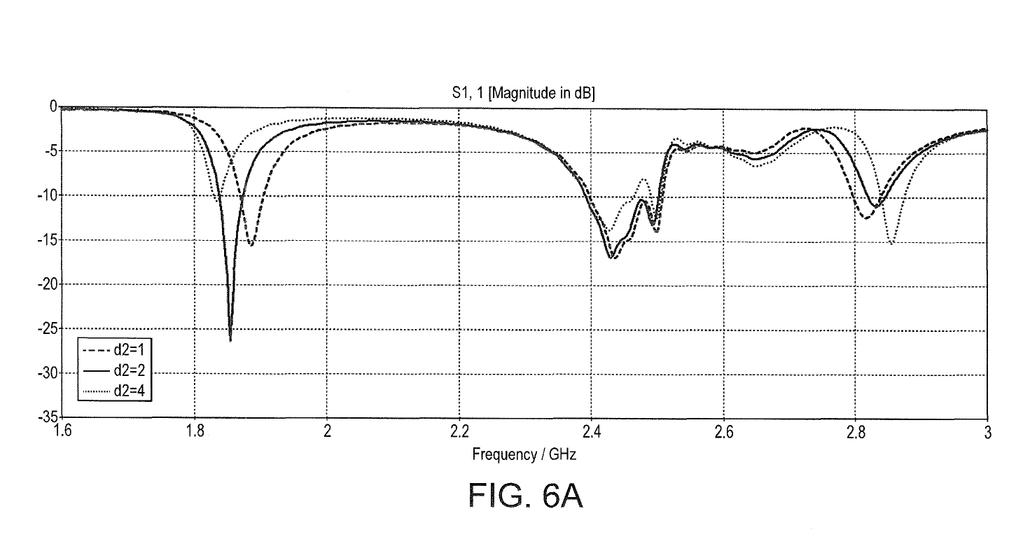

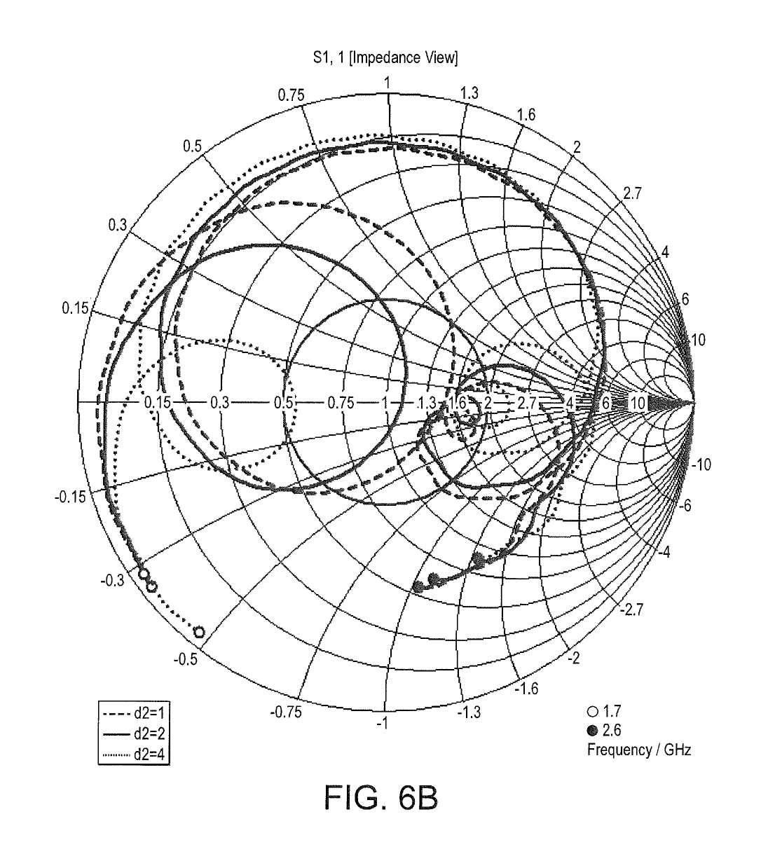

FIGS. 6A and 6B show the simulation results for the parameter d2, namely the width of the second ground plane slot 3022. The simulation results show variations in S11 over the relevant frequency range for various values of the parameter d2. Referring to FIG. 6A, the simulation results demonstrate that acceptable performance is achieved when d2 is between 1 mm and 4 mm.

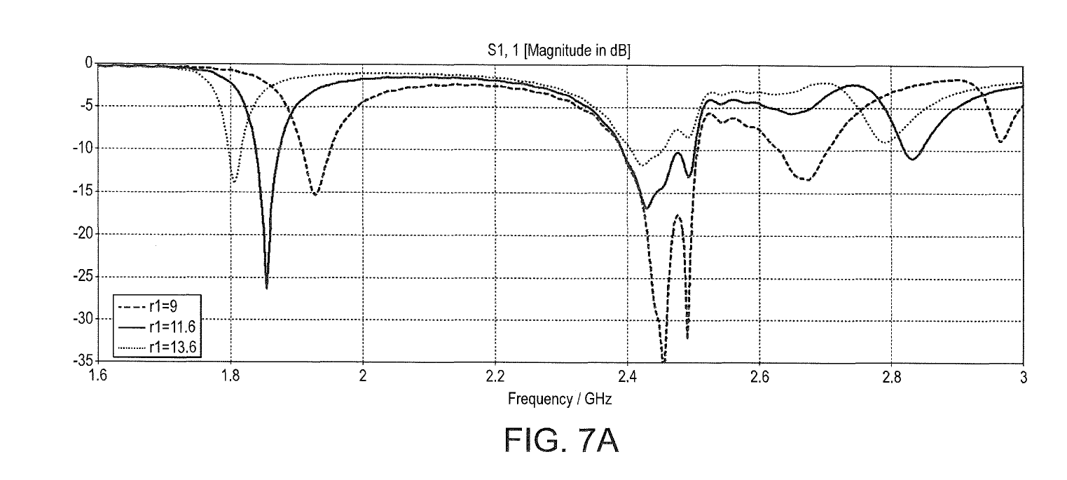

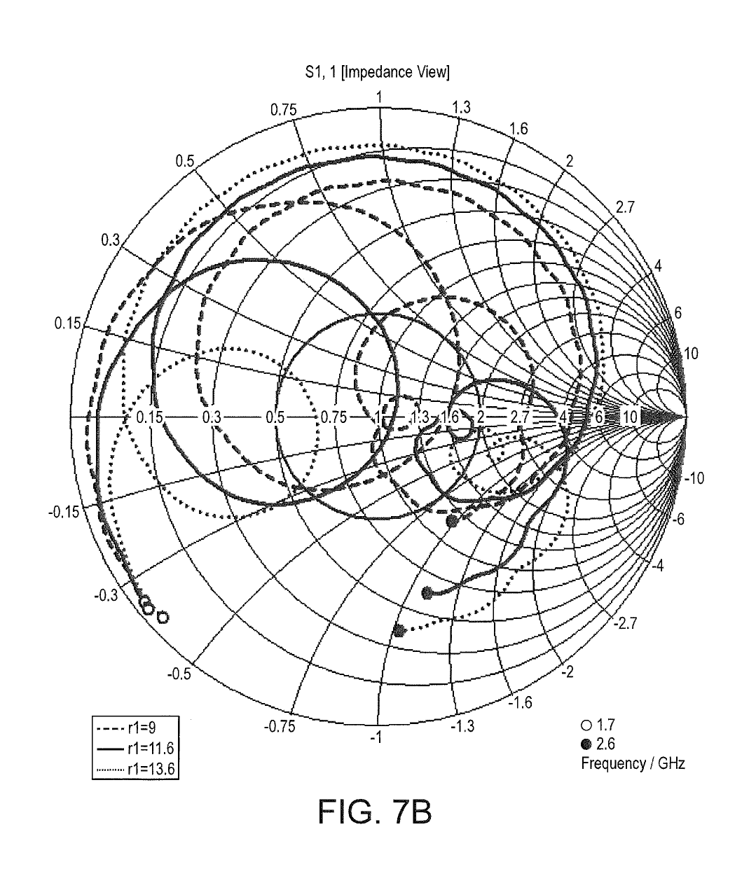

FIGS. 7A and 7B show the simulation results for the parameter r1, namely the radius of the first ground plane slot 1021 to the centre of the slot. The simulation results show variations in S11 over the relevant frequency range for various values of the parameter r1. Referring to FIG. 7A, the simulation results demonstrate that acceptable performance is achieved when r1 is between 9 mm and 13.6 mm.

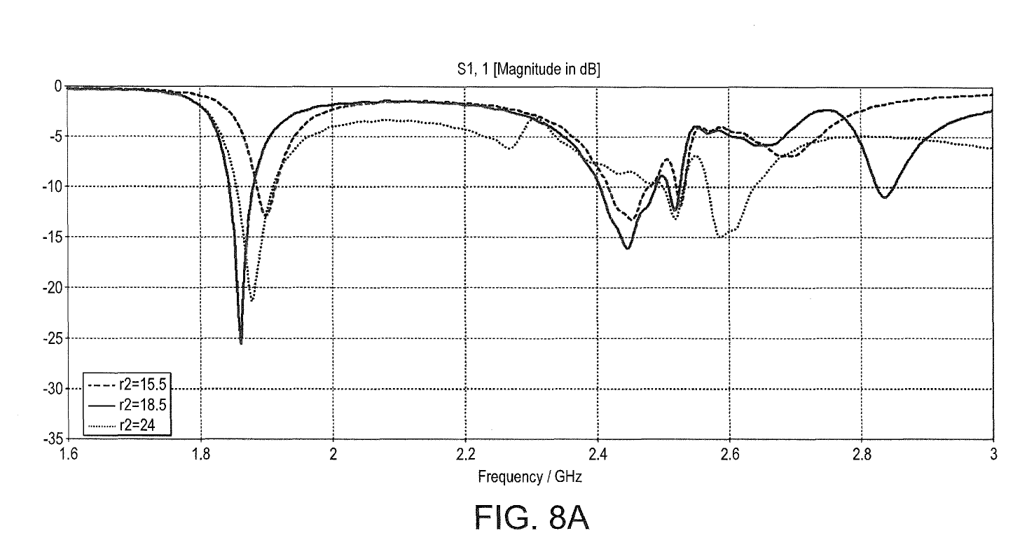

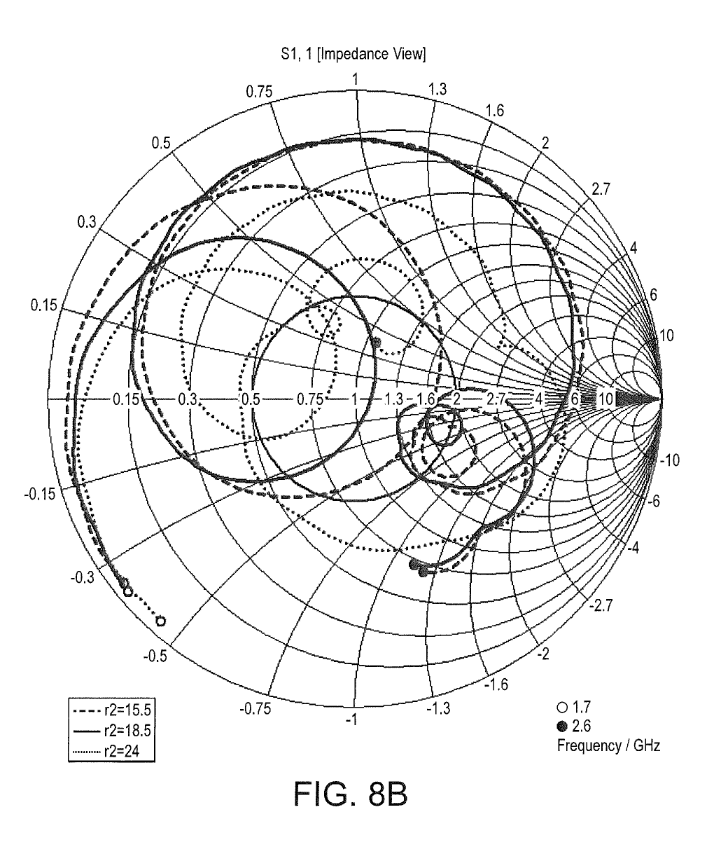

FIGS. 8A and 8B show the simulation results for the parameter r2, namely the radius of the second ground plane slot 3022 to the centre of the slot. The simulation results show variations in S11 over the relevant frequency range for various values of the parameter r2. Referring to FIG. 8A, the simulation results demonstrate that acceptable performance is achieved when r2 is between 15.5 mm and 24 mm.

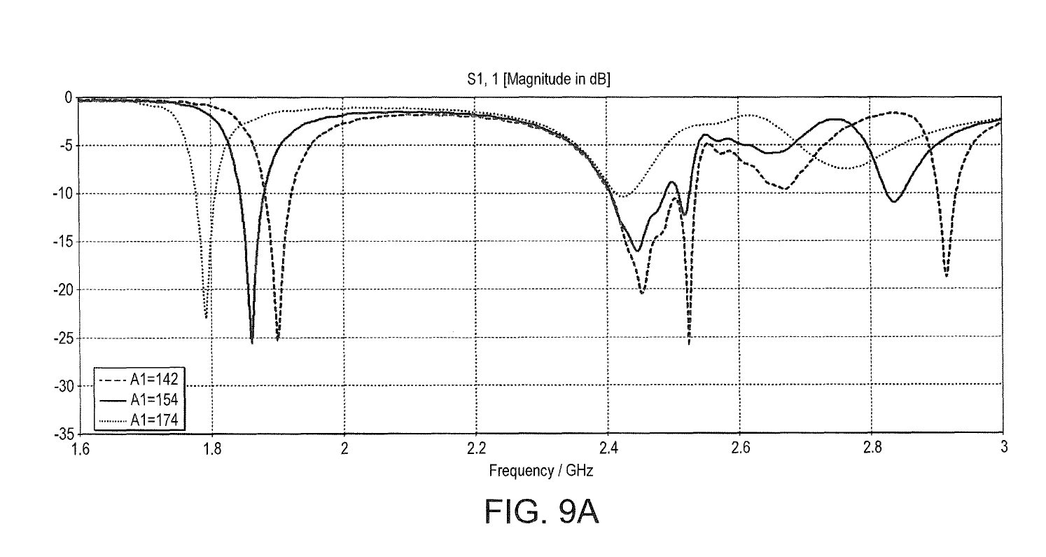

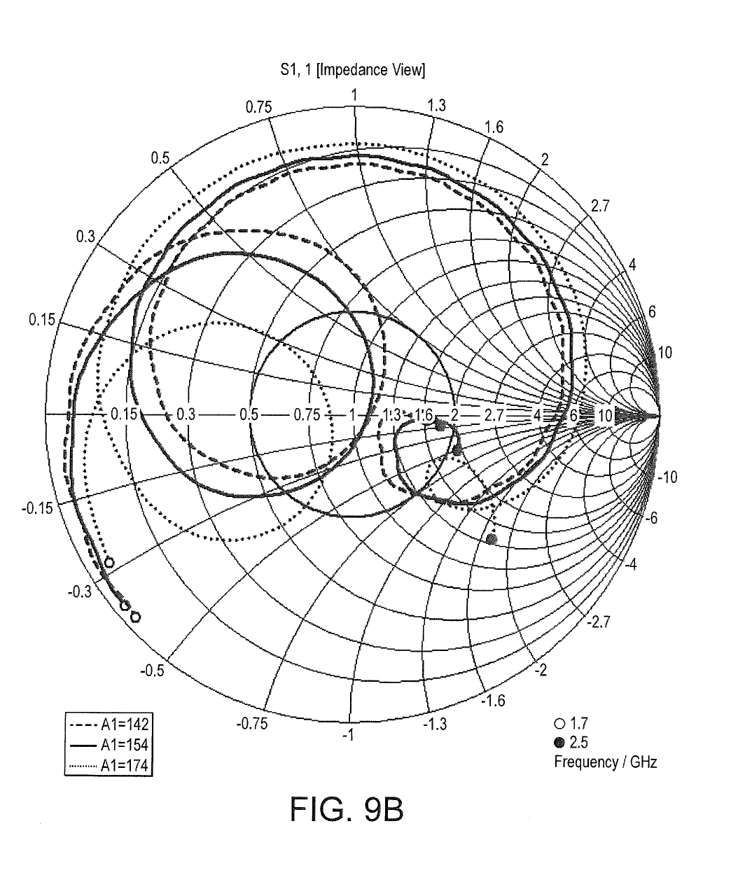

FIGS. 9A and 9B show the simulation results for the parameter A1, namely the arc angle of the first ground plane slot 1021. The simulation results show variations in S11 over the relevant frequency range for various values of the parameter A1. Referring to FIG. 9A, the simulation results demonstrate that acceptable performance is achieved when A1 is between 142° and 174°.

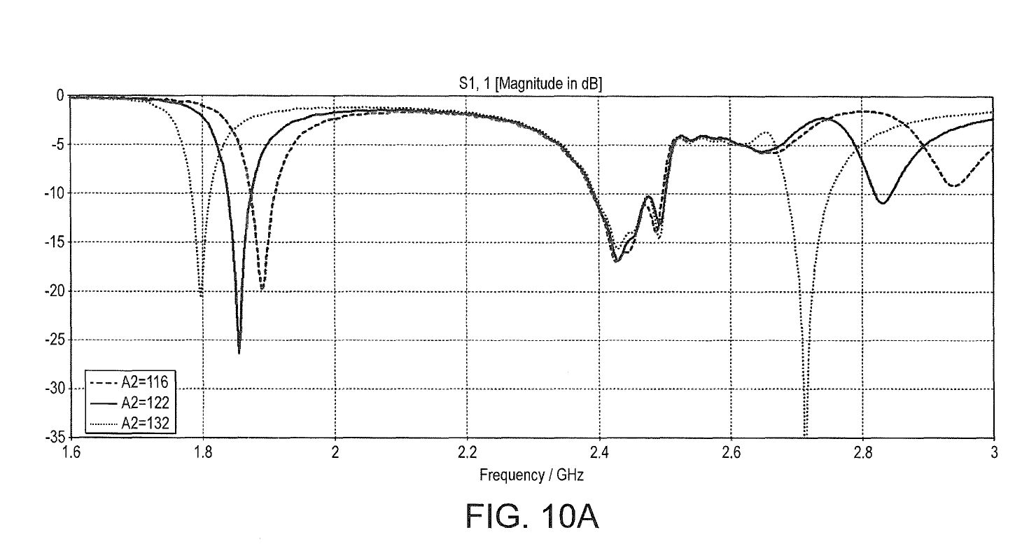

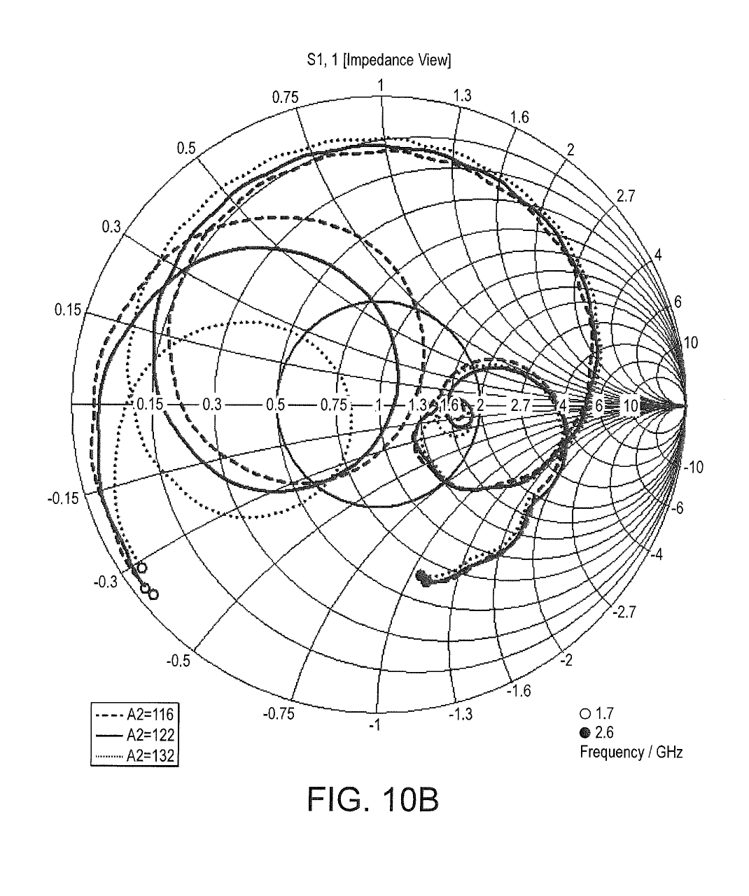

FIGS. 10A and 10B show the simulation results for the parameter A2, namely the arc angle of the second ground plane slot 3022. The simulation results show variations in S11 over the relevant frequency range for various values of the parameter A2. Referring to FIG. 10A, the simulation results demonstrate that acceptable performance is achieved when A2 is between 116° and 132°.

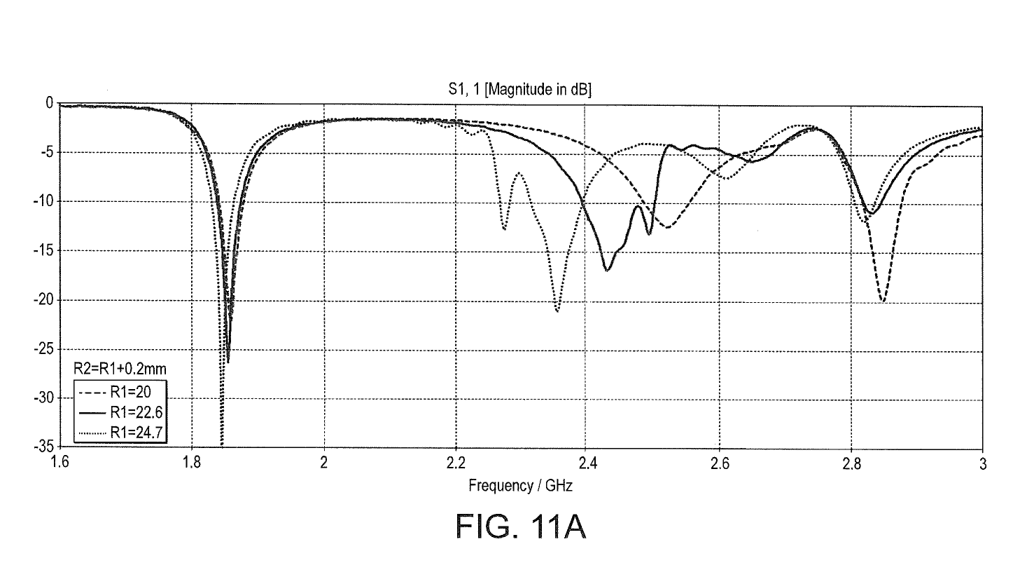

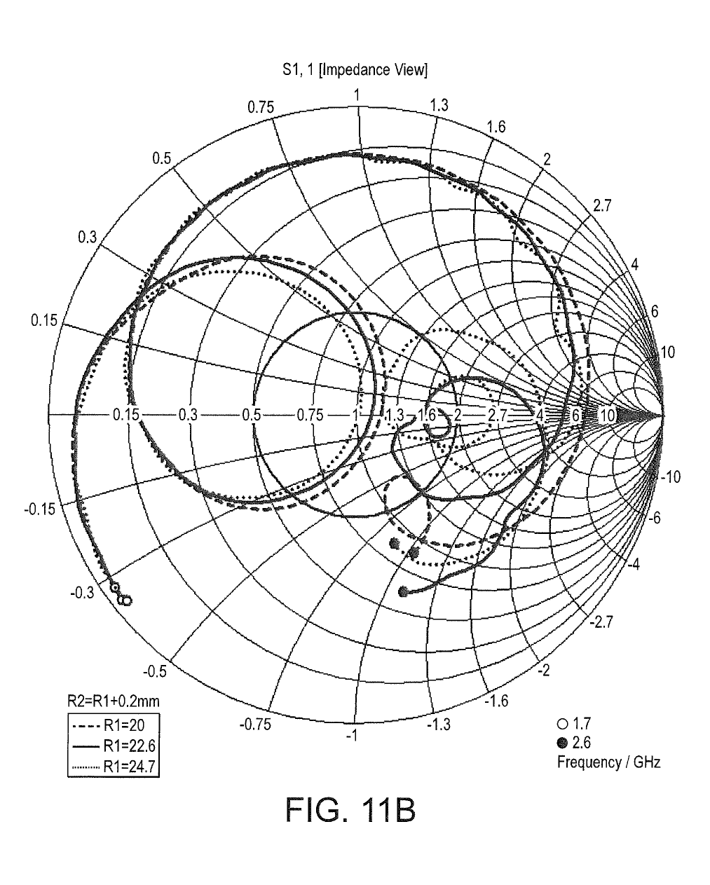

FIGS. 11A and 11B show the simulation results for the parameter R1, namely the radius from the centre of the inner section 3030 of the radiator 103 to the outer edge of the inner section 3030. The simulation results show variations in S11 over the relevant frequency range for various values of the parameter R1. Referring to FIG. 11A, the simulation results demonstrate that acceptable performance is achieved when R1 is between 20 mm and 24.7 mm.

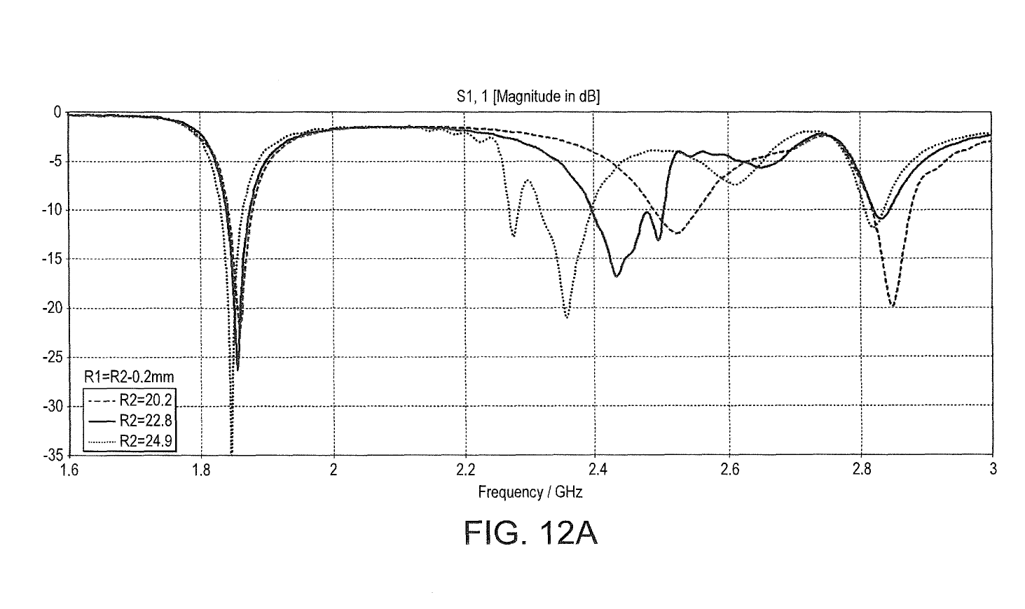

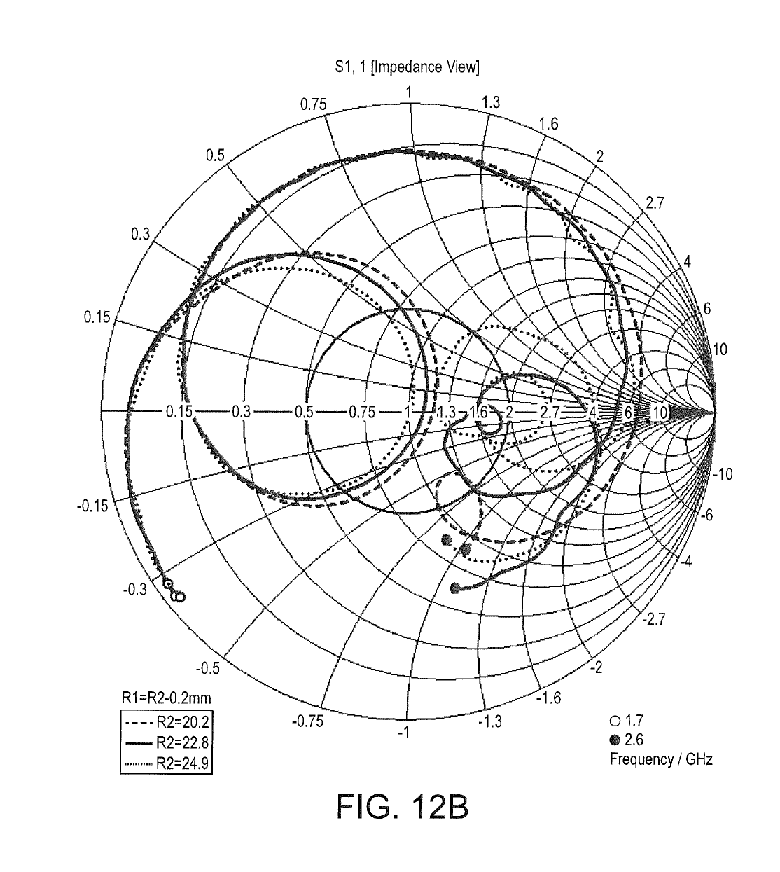

FIGS. 12A and 12B show the simulation results for the parameter R2, namely the distance from the centre of the inner section 3030 of the radiator 103 to the inside edge of the outer ring of the outer section 3032 of the radiator 103. The simulation results show variations in S11 over the relevant frequency range for various values of the parameter R2. Referring to FIG. 12A, the simulation results demonstrate that acceptable performance is achieved when R2 is between 20.2 mm and 24.9 mm.

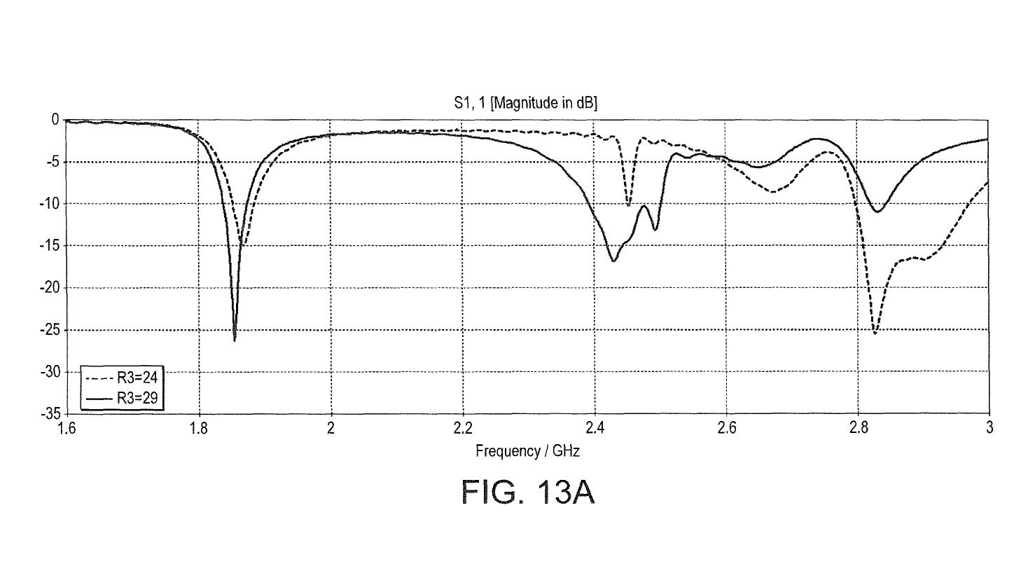

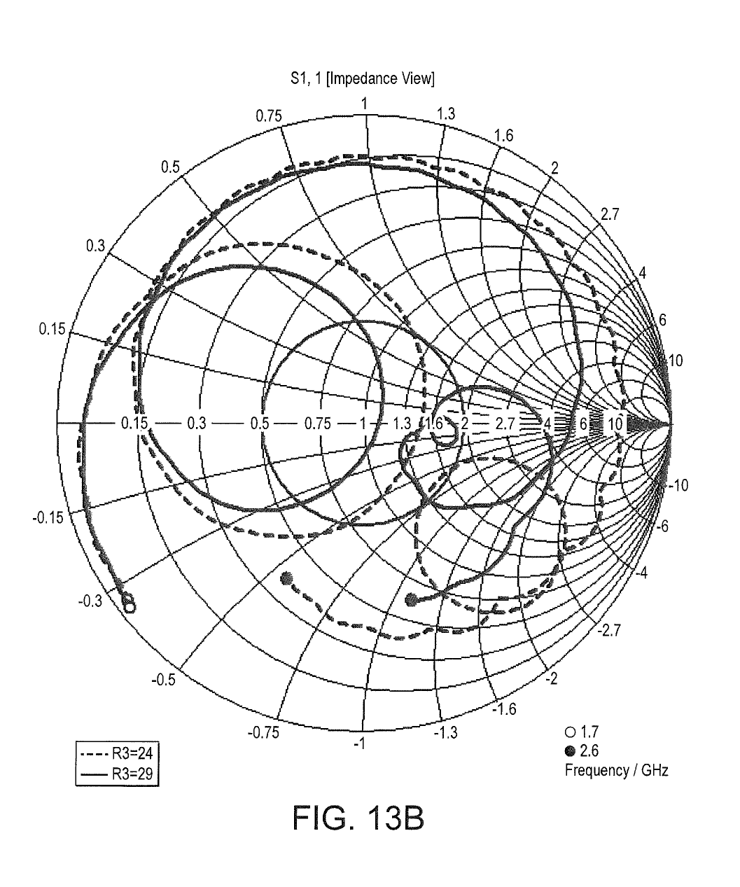

FIGS. 13A and 13B show the simulation results for the parameter R3, namely the distance from the centre of the inner section 3030 of the radiator 103 to the outside edge of the outer ring of the outer section 3032. The simulation results show variations in S11 over the relevant frequency range for various values of the parameter R3. Referring to FIG. 13A, the simulation results demonstrate that acceptable performance is achieved when R3 is between 24 mm and 29 mm.

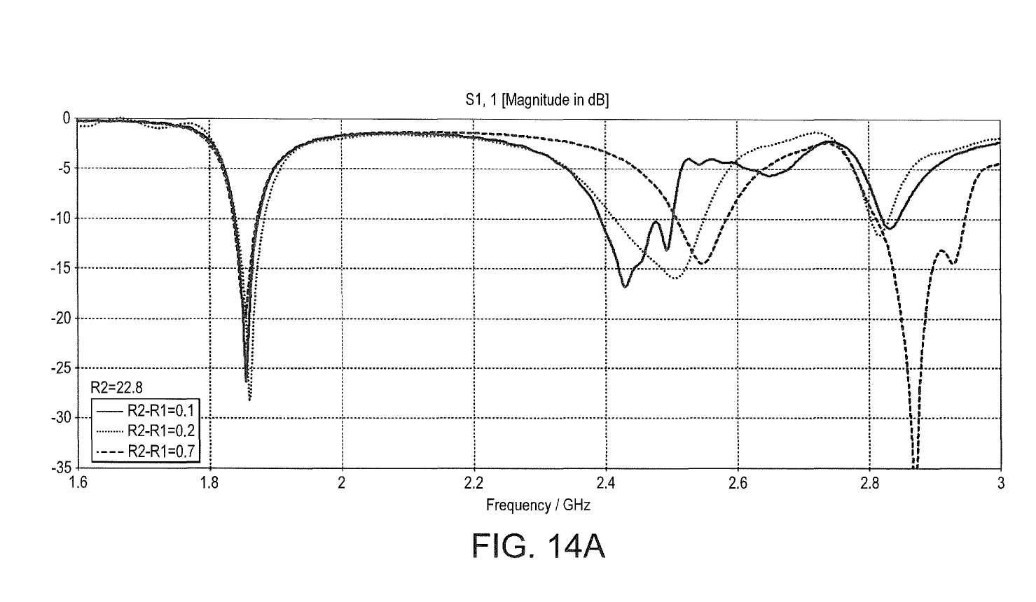

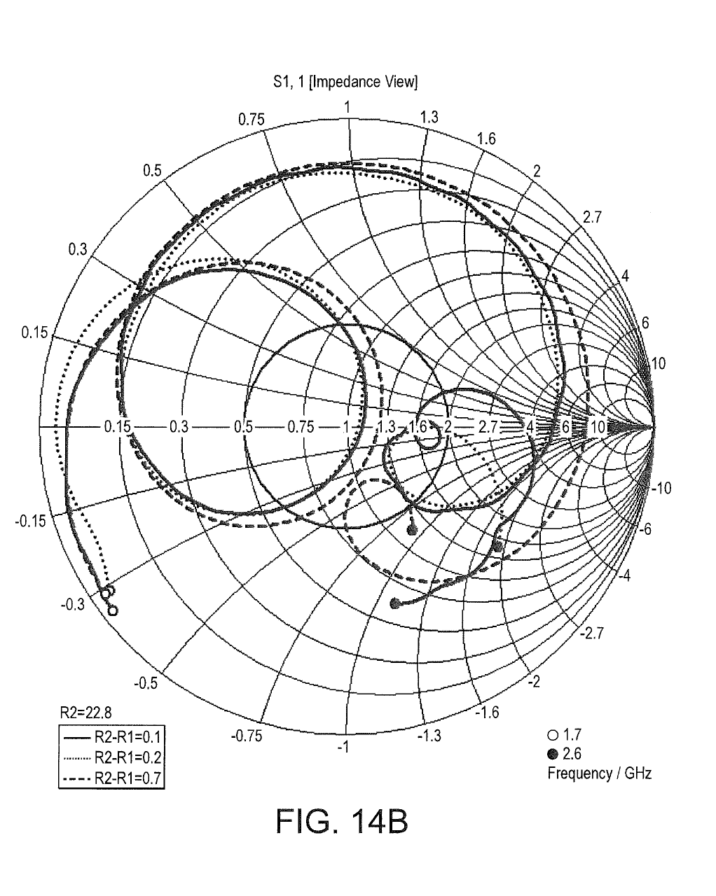

FIGS. 14A and 14B show the simulation results for the parameter R2−R1, namely the width of separating ring 3033. The simulation results show variations in S11 over the relevant frequency range for various values of the parameter R2−R1. Referring to FIG. 14A, the simulation results demonstrate that acceptable performance is achieved when R2−R1 is between 0.1 mm and 0.7 mm.

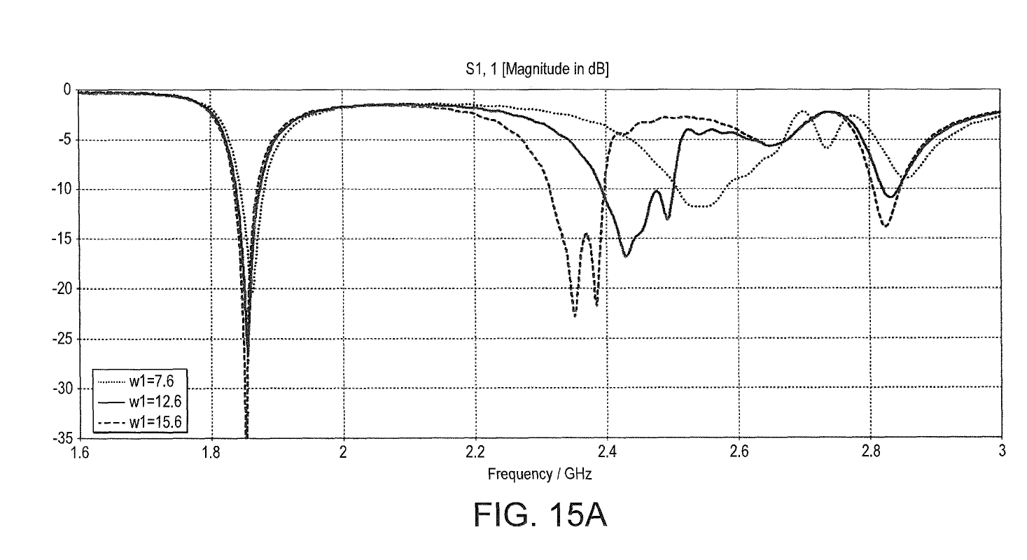

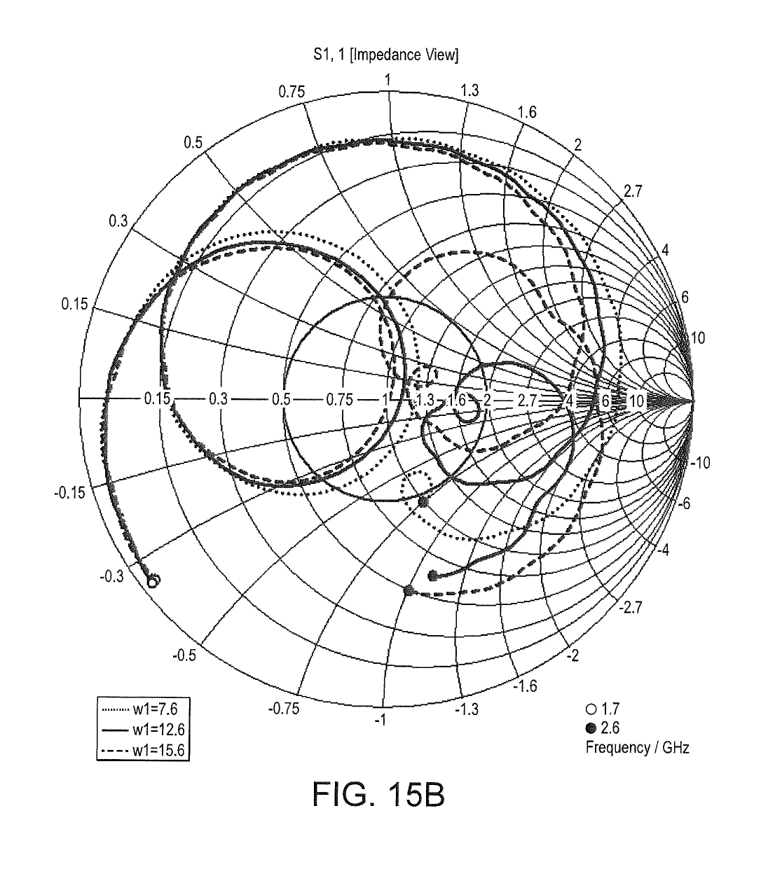

FIGS. 15A and 15B show the simulation results for the parameter w1, namely the length of each of the first 3034 and second 3035 inner radiator slots. The simulation results show variations in S11 over the relevant frequency range for various values of the parameter w1. Referring to FIG. 15A, the simulation results demonstrate that acceptable performance is achieved when w1 is between 7.6 mm and 15.6 mm.

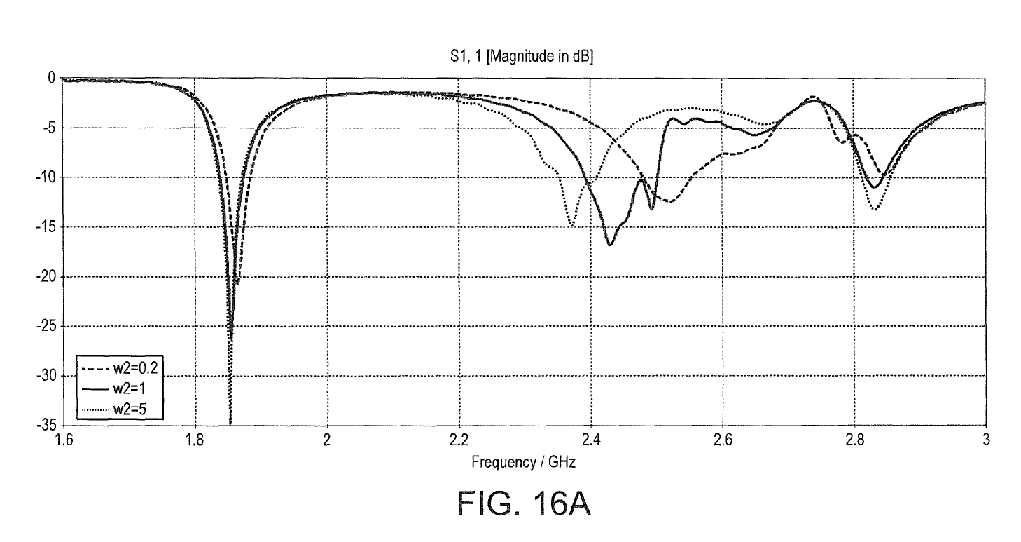

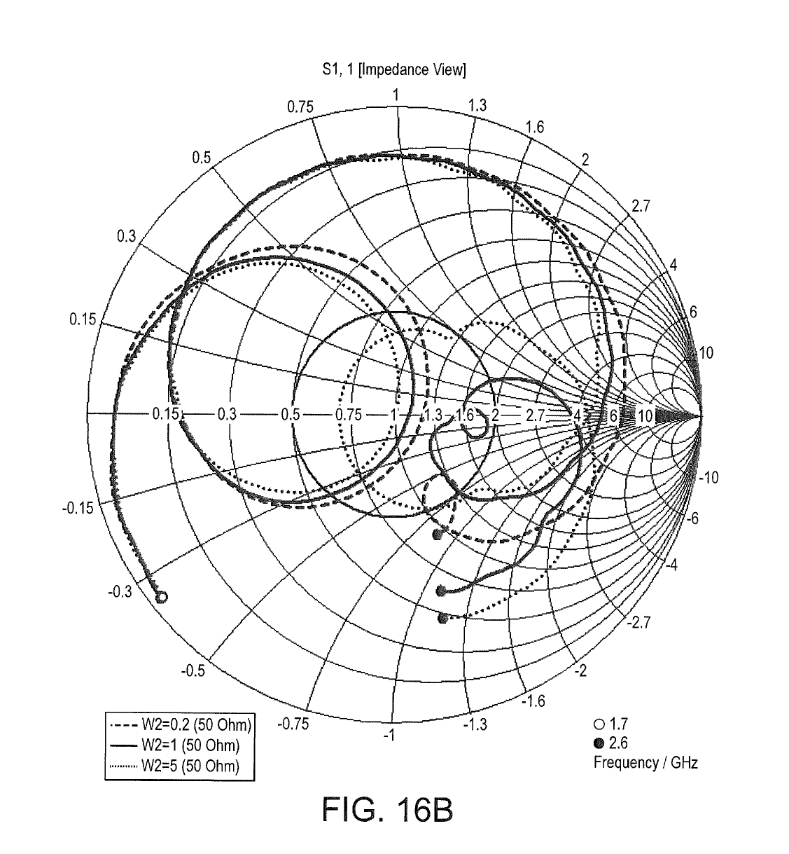

FIGS. 16A and 16B show the simulation results for the parameter w2, namely the width of the first 3034 and second 3035 inner radiator slots and/or the first 3036 and second 3037 outer radiator slots. The simulation results show variations in S11 over the relevant frequency range for various values of the parameter w2. Referring to FIG. 16A, the simulation results demonstrate that acceptable performance is achieved when w2 is between 0.2 mm and 5 mm.

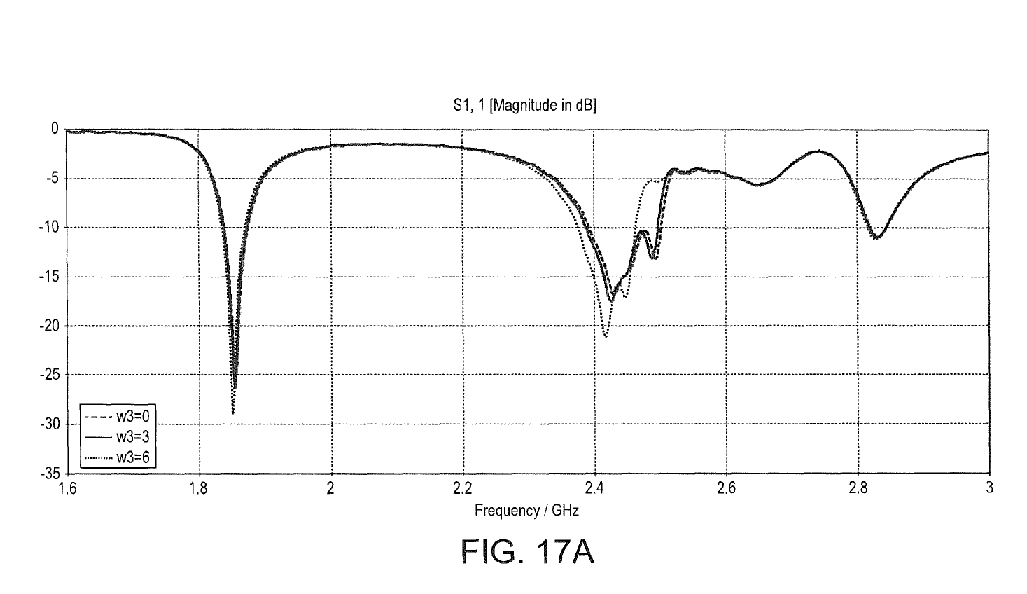

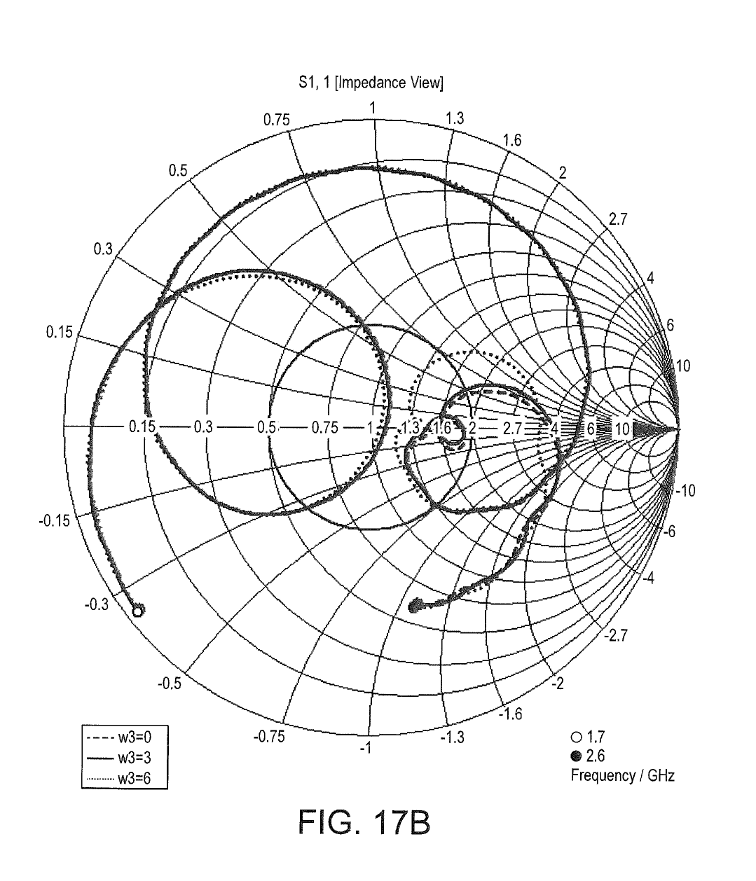

FIGS. 17A and 17B show the simulation results for the parameter w3, namely the length of each of the first 3036 and second 3037 outer radiator slots. The simulation results show variations in S11 over the relevant frequency range for various values of the parameter w3. Referring to FIG. 17A, the simulation results demonstrate that the outer radiator slots 3036, 3037 need not be present (w3=0 mm) to achieve acceptable performance and that, when the outer radiator slots 3036, 3037 are present, acceptable performance is achieved when w3 is greater than 0 mm and less than or equal to 6 mm.

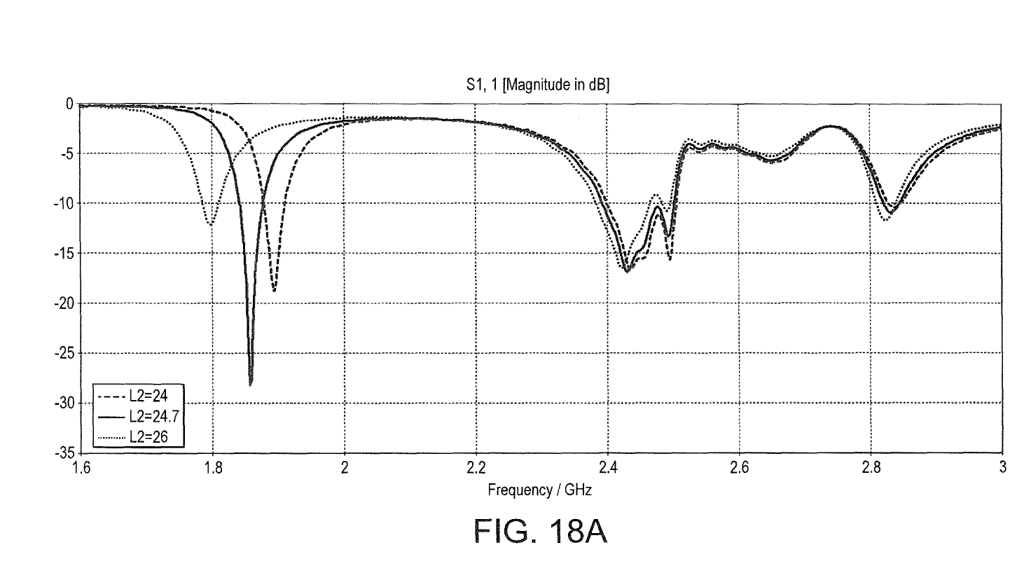

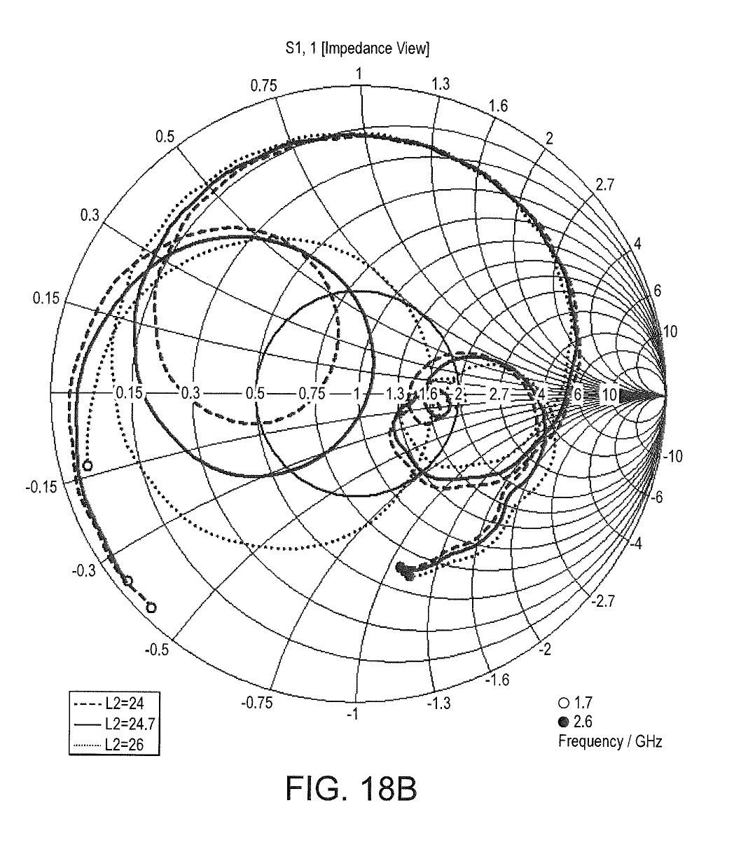

FIGS. 18A and 18B show the simulation results for the parameter L2, namely the length of the outgoing feed of the feedline 101. The simulation results show variations in S11 over the relevant frequency range for various values of the parameter L2. Referring to FIG. 18A, the simulation results demonstrate that acceptable performance is achieved when L2 is between 24 mm and 26 mm.

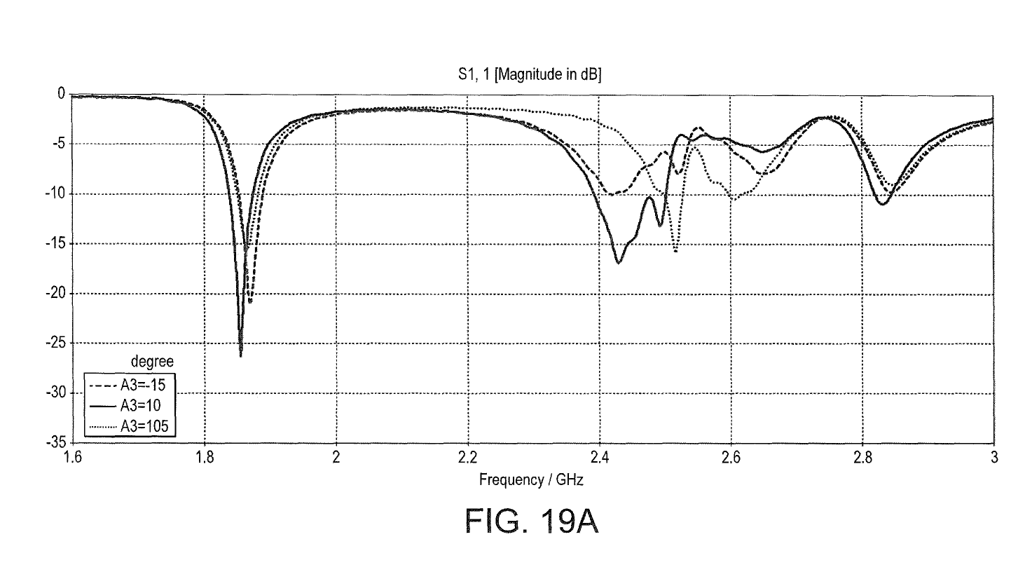

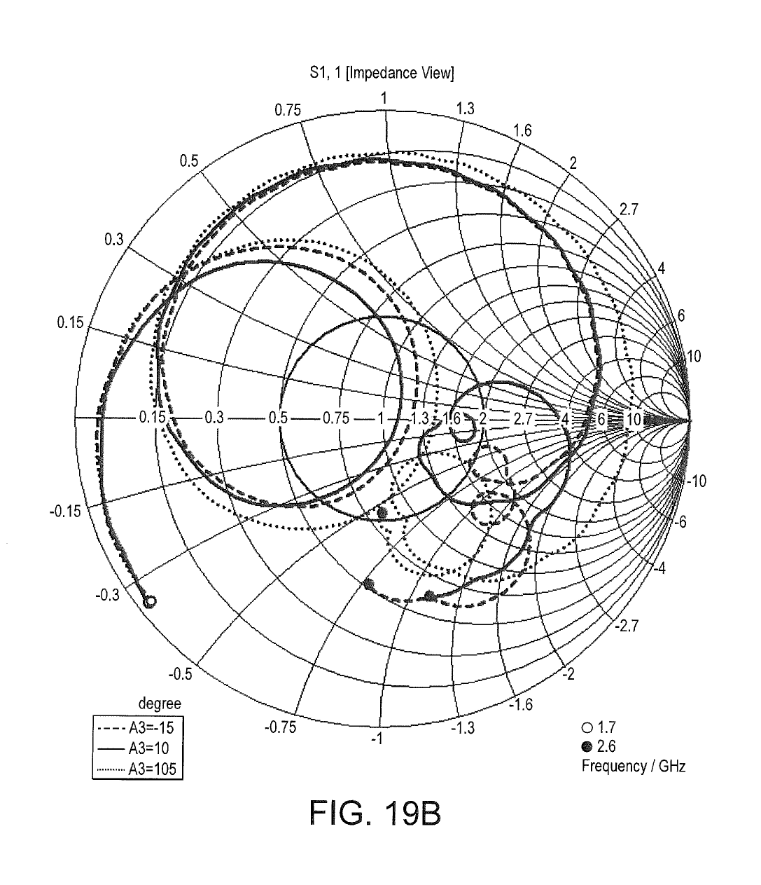

FIGS. 19A and 19B show the simulation results for the parameter A3, namely the angle between the diameter on which the first and second inner radiator slots 3034, 3035 and the first and second outer radiator slots 3036, 3037 lie and the path of the outgoing feed when the plane of the ground plane is projected into the plane of the feedline (or vice versa). The simulation results show variations in S11 over the relevant frequency range for various values of the parameter A3. Referring to FIG. 19A, the simulation results demonstrate that acceptable performance is achieved when A3 is between −15° and 105°.

### MODIFICATIONS AND VARIATIONS

In the embodiments described above, each ground plane slot 1021, 3022 is a circular arc. However, instead of being a circular arc, one or both of the ground plane slots may be any shape which intersects with the path of the feedline 101 at a first position on the first arm 1011 and a second position on the second arm 1012 when the plane of the ground plane 102 is projected onto the plane of the feedline 101 (or vice versa). For example a ground plane slot may be formed as a non-circular arc, such as an elliptical arc. The present inventors have found that performance is maximised when a ground plane slot is a circular arc and deteriorates as the arc becomes more elliptical. However, acceptable performance can be achieved when the ground plane slot is only slightly elliptical. Alternatively, the ground plane slot 1021 may be formed of straight lines.

In the embodiments described above, the radiator 103 is circular. However, the present inventors have found that acceptable antenna performance can be achieved when the radiator is slightly elliptical, with an ellipticity between 0.97 and 1.03, the ellipticity of an ellipse being defined as the ratio of the minor diameter of the ellipse and the major diameter of the ellipse. Accordingly, the term “circular” and the like when referring to the radiator should not be construed to mean strictly circular but should instead be construed to encompass such variations.

Any number of ground plane slots may be provided in the ground plane of embodiments, with a ground plane slot being provided for each waveband at which signals or energy is to be transmitted and/or received. For example, a third ground plane slot could be provided in the ground plane to provide tri-band transmission and/or reception capabilities.

In the embodiments described above, the gap between the ground plane 102 and the radiator 103 is an air gap. However, instead, the gap could be filled with foam, textile, rubber, paper, composites, polycarbonate, polyimide, kapton, silicon, or other suitable material.

In the embodiments described above, the outer radiator slots 3036, 3037 are on a diameter of the radiator 103 on opposite sides of the centre of the radiator 103 and on the outer edge of the outer section 3032 of the radiator 103. However, instead, the outer radiator slots 3036, 3037 could be on a diameter of the radiator 103 on opposite sides of the centre of the radiator 103 and on the inner edge of the outer section 3032 of the radiator 103.

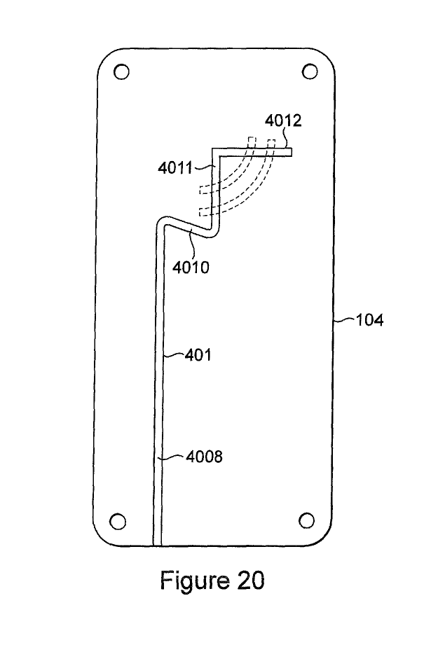

A further modification is shown in FIG. 20. In this modification, the feedline 401 is not formed of just two straight arms, as in previous embodiments. Instead, the feedline 401 has multiple arms 4008, 4010, 4011, 4012 (four in the example of FIG. 20 although other numbers are possible). This has the advantage of freeing up space on the substrate 104 on which the feedline 401 is formed. This allows the feedline 401 to avoid any circuitry which may be present. Accordingly, the substrate can have thereon transmission and/or reception circuitry, so that the circuitry and antenna are integrated on one substrate. In the example shown in FIG. 20, arm 4012 is the output feed.

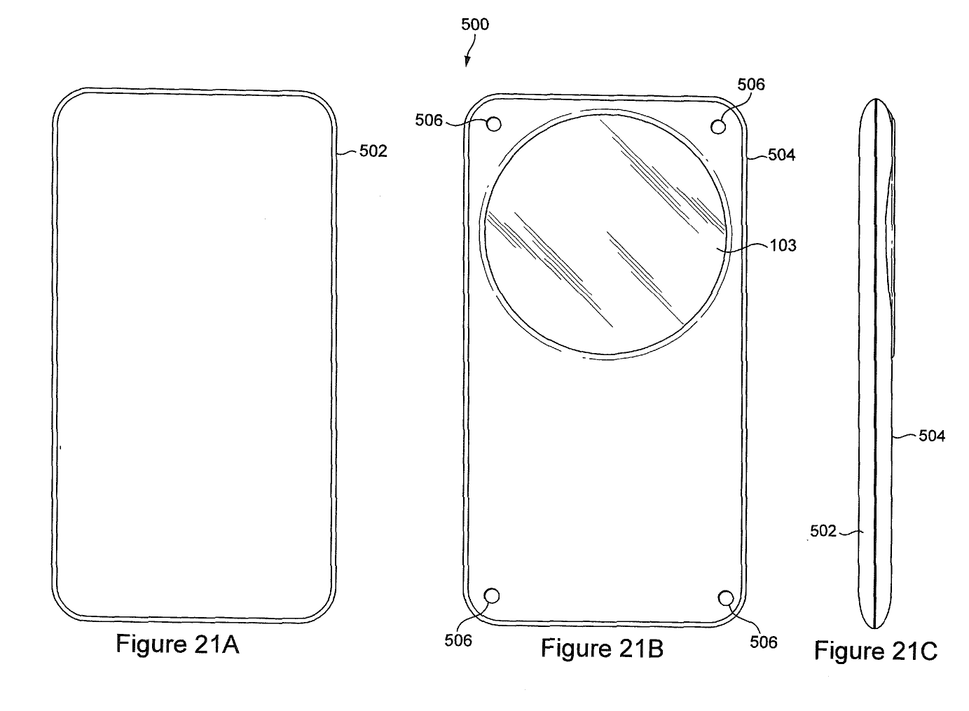

FIGS. 21A, 21B and 21C show a further modification in which a case 500 is provided to house the substrate 104 with the feedline and ground plane thereon, and in which the radiator 103 is printed or plated on the inside of the case 500. More particularly, referring to FIGS. 21A and 21B the case 500 comprises a base 502 and a lid 504. Lid 504 contains supports 506 to engage holes in substrate 104 to position and hold substrate 104 in a predetermined position relative to radiator 103, which is printed or plated on the inside of the lid 504. FIG. 21C shows the case 500 with the base 502 and lid 504 connected together to form a device housing an antenna. Printing or plating radiator 103 on the inside of case 500 provides a mechanical support for the radiator, while reducing manufacturing cost and reducing the manufacturing process time.

The foregoing description of embodiments of the invention has been presented for the purpose of illustration and description. It is not intended to be exhaustive or to limit the invention to the precise form disclosed. Alternations, modifications and variations can be made without departing from the spirit and scope of the present invention.

1. An antenna comprising:
a feedline having a path in a first plane, the path having a first arm and a second arm perpendicular to the first arm;
a ground plane provided in a second plane spaced apart from, and parallel to, the first plane, the ground plane having a ground plane slot therein with a path in the second plane, wherein the path of the ground plane slot intersects the path of the feedline at a first position on the first arm and a second position on the second arm when the second plane is projected into the first plane; and
a radiator separated from the feedline by the ground plane, the radiator being provided in a third plane spaced apart from, and parallel to, the second plane.

2. The antenna of claim 1, wherein the ground plane slot is arcuate.

3. The antenna of claim 2, wherein the ground plane slot is an elliptical arc.

4. The antenna of claim 2, wherein the ground plane slot is a circular arc.

5. The antenna of claim 4, wherein the centre of the circular arc is at the intersection of the first arm and the second arm when the second plane is projected into the first plane.

6. The antenna of claim 4 or claim 5, wherein the bisector of the arc angle of the ground plane slot bisects the angle between the first and second arms when the second plane is projected into the first plane.

7. The antenna of any preceding claim, wherein the radiator is circular.

8. The antenna of claim 7, wherein the centre of the radiator is at the intersection of the first arm and the second arm when the third plane is projected into the first plane.

9. The antenna of claim 7 or claim 8, wherein the radiator has a first radiator slot and a second radiator slot, the first and second radiator slots being on a diameter of the radiator on opposite sides of the centre and at the edge of the radiator.

10. The antenna of claim 1, wherein:
the ground plane has a first ground plane slot and a second ground plane slot therein, each ground plane slot having a path in the second plane;
the path of the first ground plane slot intersects the path of the feedline at a first position on the first arm and a second position on the second arm when the second plane is projected into the first plane;
the path of the second ground plane slot intersects the path of the feedline at a third position on the first arm and a fourth position on the second arm when the second plane is projected into the first plane; and
the radiator comprises:
an inner section formed of an inner portion of the radiator; and
an outer section formed of an outer ring of the radiator.

11. The antenna of claim 10, wherein each of the first and second ground plane slots is arcuate.

12. The antenna of claim 11, wherein each of the first and second ground plane slots is an elliptical arc.

13. The antenna of claim 11, wherein each of the first and second ground plane slots is a circular arc.

14. The antenna of claim 13, wherein the circular arcs of the first and second ground plane slots have the same centre and the centre is at the intersection of the first arm and the second arm when the second plane is projected into the first plane.

15. The antenna of claim 13 or claim 14, wherein the bisector of the arc angle of the first ground plane slot is also a bisector of the arc angle of the second ground plane slot and bisects the angle between the first and second arms when the second plane is projected into the first plane.

16. The antenna of any of claims 10 to 15, wherein the radiator is circular.

17. The antenna of claim 16, wherein the centre of the radiator is at the intersection of the first arm and the second arm when the third plane is projected into the first plane.

18. The antenna of claim 16 or claim 17, wherein the inner section of the radiator is circular with a first inner radiator slot and a second inner radiator slot, the first and second inner radiator slots lying on a diameter of the inner section of the radiator on opposite sides of the centre and at the edge of the inner section.

19. The antenna of any of claims 16 to 18, wherein the outer section of the radiator has a first outer radiator slot and a second outer radiator slot, the first and second outer radiator slots lying on a diameter of the radiator on opposite sides of the centre of the radiator and at an edge of the outer section.

20. The antenna of any of claims 16 to 19, wherein:
the inner section of the radiator has a first inner radiator slot and a second inner radiator slot, the first and second inner radiator slots lying on a diameter of the radiator on opposite sides of the centre of the radiator and at the edge of the inner section; and
the outer section of the radiator has a first outer radiator slot and a second outer radiator slot, the first and second outer radiator slots lying on the diameter of the radiator on opposite sides of the centre of the radiator and at an edge of the outer section.

21. The antenna of claim 1, wherein:
the ground plane has a first ground plane slot and a second ground plane slot therein, each ground plane slot having a path that is a circular arc in the second plane;
the path of the first ground plane slot intersects the path of the feedline at a first position on the first arm and a second position on the second arm when the second plane is projected into the first plane;
the path of the second ground plane slot intersects the path of the feedline at a third position on the first arm and a fourth position on the second arm when the second plane is projected into the first plane;
the circular arcs of the first and second ground plane slots have the same centre and the centre is at the intersection of the first arm and the second arm when the second plane is projected into the first plane;
the radiator is circular and comprises:
a circular inner section; and
an outer section formed of an outer circular ring electrically separated from the inner section by a circular separating ring;
and wherein:
the inner section of the radiator has a first inner radiator slot and a second inner radiator slot, the first and second inner radiator slots lying on a diameter of the radiator on opposite sides of the centre and at the edge of the inner section.

22. The antenna of claim 21, wherein the bisector of the arc angle of the first ground plane slot is also a bisector of the arc angle of the second ground plane slot and bisects the angle between the first and second arms when the second plane is projected into the first plane.

23. The antenna of claim 21 or claim 22, wherein the centre of the radiator is at the intersection of the first arm and the second arm when the third plane is projected into the first plane.

24. The antenna of any of claims 21 to 23, wherein the width of the first ground plane slot is between 0.6 mm and 3.4 mm.

25. The antenna of any of claim 21 to claim 24, wherein the width of the second ground plane slot is between 1 mm and 4 mm.

26. The antenna of any of claims 21 to 25, wherein the first ground plane slot has a radius to the centre of the slot between 9 mm and 13.6 mm.

27. The antenna of any of claims 21 to 26, wherein the second ground plane slot has a radius to the centre of the slot between 15.5 mm and 24 mm.

28. The antenna of any of claims 21 to 27, wherein the first ground plane slot has an arc angle in the ground plane between 142° and 174°.

29. The antenna of any of claims 21 to 28, wherein the second ground plane slot has an arc angle in the ground plane between 116° and 132°.

30. The antenna of any of claims 21 to 29, wherein the radius from the centre of the inner section of the radiator to the outer edge of the inner section is between 20 mm and 24.7 mm.

31. The antenna of any of claims 21 to 30, wherein the distance from the centre of the inner section of the radiator to the inside edge of the outer ring of the outer section of the radiator is between 20.2 mm and 24.9 mm.

32. The antenna of any of claims 21 to 31, wherein the distance from the centre of the inner section of the radiator to the outside edge of the outer ring of the outer section of the radiator is between 24 mm and 29 mm.

33. The antenna of any of claims 21 to 32, wherein the width of the separating ring is between 0.1 mm and 0.7 mm.

34. The antenna of any of claims 21 to 33, wherein the length of each of the first and second inner radiator slots is between 7.6 mm and 15.6 mm.

35. The antenna of any of claims 21 to 34, wherein the width of each of the first and second inner radiator slots is between 0.2 mm and 5 mm.

36. The antenna of any of claims 21 to 35, wherein one of the first and second arms is an outgoing feed and the diameter on which the first and second inner radiator slots lie forms an angle between −15° and 105° relative to the path of the outgoing feed when the second plane is projected into the first plane.

37. The antenna according to any of claims 21 to 36, wherein one of the first and second arms is an outgoing feed and the length of the outgoing feed is between 24 mm and 26 mm.

38. The antenna of any of claims 21 to 37, wherein the outer section of the radiator has a first outer radiator slot and a second outer radiator slot, the first and second outer radiator slots lying on the same diameter as the first and second inner radiator slots on opposite sides of the centre of the radiator and at an edge of the outer section.

39. The antenna of claim 38, wherein the length of each of the first and second outer radiator slots is greater than 0 mm and less than or equal to 6 mm.

40. The antenna of claim 38 or claim 39, wherein the width of each of the first and second outer radiator slots is between 0.2 mm and 5 mm

41. A device comprising an antenna according to any preceding claim, wherein the radiator is printed or plated onto the case of the device.
